(19) United States
(12) Patent Application Publication
(10) Pub. No.: US 2010/0072284 A1
(43) Pub. Date: Mar. 25, 2010

(54) SEMICONDUCTOR DEVICE AND ADAPTOR FOR THE SAME

(75) Inventors: Hirotaka NISHIZAWA, Tokyo (JP); Hideo KOIKE, Tokyo (JP); Hironori IWASAKI, Tokyo (JP); Junichiro OSAKO, Tokyo (JP); Minoru SHINOHARA, Tokyo (JP); Tamaki WADA, Tokyo (JP); Takashi TOTSUKA, Tokyo (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/517,385

(22) PCT Filed: Dec. 12, 2007
(86) PCT No.: PCT/JP2007/073931

§ 371 Date: Jun. 3, 2009

(30) Foreign Application Priority Data
Dec. 20, 2006 (JP) 2006-342766

(51) Int. Cl. G06K 19/07; H01R 24/00

(52) U.S. Cl. 235/492; 439/629

(57) ABSTRACT

Connector terminals are arranged at the center of a thin memory card 1802, thereby preventing an electrical short circuit between the terminals. A step is provided to the thin memory card 1802, thereby allowing the IC chips to be stacked in a thick portion. Adhesion portions of the connector terminals 3303 are located at a position on a card insertion port side of a substrate 3002, thereby preventing the destruction of the connector terminals at the time of the card insertion. An upper retainer lid 3003 is provided on an upper portion of the connector terminals 3303, thereby preventing the deflection of the card.

### TECHNICAL FIELD

The present invention relates to a semiconductor device, and more particularly to an IC card capable of being separated into an adaptor and a card body.

### BACKGROUND ART

As the techniques examined by the present inventors, for example, the following technique is conceivable in the IC card.

For example, as one type of the IC card, there is a card referred to as a SIM card (Subscriber Identity Module Card). The SIM card is an IC card recorded with subscriber information, and it is inserted into a mobile phone to identify a user. Even for the phone of a different system, the phone number and billing information can be directly taken over by replacing and using a common IC card, and this is realized as a GSM (Global System for Mobile Communications) card in a GSM mobile phone. The outer dimensions of the SIM card use an ID-000 format of 15 mm×25 mm×0.76 mm. More specifically, the planar dimensions are 15 mm×25 mm and the thickness is approximately 0.76 mm. On the surface thereof, external interface terminals (ISO7816 interface terminals) defined by the standards of the terminal position and the function of ISO/IEC7816-3 are arranged.

FIG. 1A is a block diagram showing the configuration of a smart card of Plug-in SIM (ID-000) examined as a premise of the present invention, and FIG. 1B is a drawing showing terminal allocation according to the ISO7816.

As shown in FIG. 1A, the SIM card is mounted with a microcomputer (SIC) including CPU, ROM, RAM, EEPROM and the like as a secure IC chip. An antenna coil such as LA and LB and a non-contact interface are optional and can be omitted.

As shown in FIG. 1B, eight pieces of the ISO7816 interface terminals from C1 to C8 are arranged on a bottom side of the SIM card, and the ISO7816 terminals are allocated so that C1 is VCC (+power supply), C2 is RES (reset), C3 is CLK (clock), C4, C6 and C8 are RSV (reserve), C5 is VSS (ground), and C7 is I/O (input/output). Here, the reserve terminals can be used as extended terminals for the realization of a USB interface, the realization of MMC (Multi Media Card, registered trademark of Infineon Technologies) and serial interface or the realization of non-contact (contactless card) function.

FIG. 2A is a structural drawing viewed from a SIC chip mounting side (opposite side of FIG. 1B) of the SIM card examined as a premise of the present invention. FIG. 2B is a cross sectional view along the line A-A′ of FIG. 2A, and FIG. 2C is a cross sectional view along the line B-B′ of FIG. 2A. Note that, in FIG. 2A, dashed line illustration is applied in order to clarify the corresponding relation of the ISO7816 interface terminals C1 to C8 shown in FIG. 1B, the grooves of cavities, and the position where the SIC chip is disposed.

As shown in FIG. 2B and FIG. 2C, a SIC chip is mounted on a substrate having electrodes of ISO7816 (ISO7816 interface terminals) on its bottom surface, and the terminals of the SIC chip and the ISO7816 electrodes are wire-bonded through openings on the substrate. The SIC chip on the substrate is sealed by resin mold, and the plastic forming the outer shape of the card and the substrate are connected by a double-faced adhesive tape. In FIG. 2B and FIG. 2C, the RSV terminals are not connected to the terminals of the SIC chip.

As the technique regarding such an IC card, for example, the technique disclosed in Patent Document 1 can be cited.

The patent Document 1 discloses an IC card module including a microcomputer, a memory card controller, and a flash memory. In this IC card module, a plurality of first external connection terminals and a plurality of second external connection terminals are exposed on one surface of a card substrate, and the IC card module includes a microcomputer connected to the first external connection terminals, a memory card controller connected to the second external connection terminals, and a flash memory connected to the memory card controller. The shape of the card substrate and the arrangement of the first external connection terminals conform to the standards of the Plug-in UICC (Universal Integrated Circuit Card) of ETSI-TS-102-221-V4.4.0 (2001-10) or have interchangeability. The second external connection terminals are arranged outside the minimum range of the terminal arrangement according to the standards of the first external connection terminals, and signal terminals of the first and second external connection terminals are electrically separated from each other. By this means, the interchangeability with the SIM card and the adaptation to high speed memory access are realized.

Further, Non-Patent Document 1 discloses the technique regarding a common smart card.

[Patent Document 1] Japanese Patent Application Laid-Open Publication No. 2005-322109

[Non-Patent Document 1] W. Raukl & W. Effing, “Smart Card Handbook” Second Edition, WILEY, P. 27-31

### DISCLOSURE OF THE INVENTION

### Problem to be Solved by the Invention

Now, as a result of the examination regarding the technique of such an IC card by the present inventors, the followings have been revealed.

For example, though the SIC chip is mounted with a non-volatile memory such as an EEPROM, a memory capacity becomes insufficient depending on the way of use. The memory capacity may be extended by mounting a flash memory as an extended memory like in the Patent Document 1. However, mounting the flash memory having a fixed memory capacity uniformly for all the users is not only inadequate for a user who does not require the flash memory capacity and a user who requires larger capacity but also an enormous cost burden. As a non-volatile extended memory such as the flash memory, a memory whose extendability of the memory capacity is large and which can achieve a memory capacity and cost burden in accordance with the requirements of users is desirable.

Also, for the purpose of protecting private information, for example, it is desired to strengthen a security function and a tamper-resistant function in a memory region and to achieve the portability among IC cards in different shapes.

For its achievement, the following solution has been considered.

That is, a semiconductor device is provided as a removable memory card (card body) capable of separating a necessary memory region such as a flash memory from a SIM card. Then, the removable memory card (card body) can be inserted into a plug-in a SIM (Subscriber Identity Module) adaptor or a miniUICC (Universal Integrated Circuit Card) adaptor. When this removable memory card (card body) is inserted into the SIM adaptor or the miniUICC adaptor, the SIM adaptor or the miniUICC adaptor (hereinafter simply referred to as “adaptor”) and the removable memory card (card body) (hereinafter simply referred to as “card”) integrally operate as an extended-memory-attached SIM or an extended-memory-attached miniUICC, or a conventional Plug-in SIM or miniUICC.

However, as a result of the examination of the technique described above, the following individually dependent major problems have been revealed. These problems will be described with reference to FIGS. 3 to 10.

<First Problem>

To begin with, a first problem is an electrical short circuit between terminals.

FIG. 3 is a drawing showing an insertion state of a card into a connector portion mounted or formed in the adaptor, in which FIG. 3A shows the state before the card is inserted and FIG. 3B shows the state after the card is inserted.

As shown in FIG. 3A, connector terminals for electrical connection to the terminals of the card A are attached to a connector housing for card A of the adaptor. A card insertion port of the connector housing for card A has a width W1. Also, on a surface of the card A, the plurality of card terminals for electrical connection to the connector terminals are formed at an end portion of the card.

As shown in FIG. 3B, the card A whose fitting to the connector width W1 is adjusted can be inserted without unwanted wobbling. Therefore, when the card A is inserted into the connector housing for card A, the target terminal and connector are electrically connected, so that no unwanted electrical short circuit between other terminal and connector occurs.

FIG. 4 is a drawing showing an example of the occurrence of an electrical short circuit when a card B whose width is so narrower than the width W1 that the corresponding dimensions of the terminal pitch are affected is inserted into the connector housing for card A of the adaptor, in which FIG. 4A shows an example of a state in which the card B is inserted into the connector for card A, FIG. 4B is an enlarged plan view of a portion “a” in FIG. 4A, and FIG. 4C is an enlarged perspective view of the portion “a”.

As shown in FIG. 4A, when a width W2 of the card B is narrower than the connector insertion width W1 of the connector housing for card A (W1>W2), if the card B having terminals at a card end portion is inserted, connector terminals are sometimes positioned in the spaces between card terminals. At this time, a contact failure called chattering occurs in some cases, in which either or both of the card terminals repeat the electrical short circuit and open via the connector terminal.

FIGS. 4B and 4C show a state in which the card B is positionally shifted, so that connector terminals (power supply terminals VCC and VSS) are positioned between two card terminals and one connector terminal is in contact with the two card terminals. At this time, the connector terminal is connected to both of the card terminals, so that a short circuit occurs between the power supply terminals VCC and VSS. Although only the power supply terminals VCC and VSS are shown in FIGS. 4B and 4C, this phenomenon similarly occurs not only for power supply terminals but also for signal terminals.

FIG. 5 is a drawing showing an example of the occurrence of an electrical short circuit when the card B with a narrow width is inserted into the connector having double-contact power supply terminals designed so that two connector terminals are connected to one card terminal, in which FIG. 5A shows a state in which the card B is inserted into the connector for card A, FIG. 5B is an enlarged plan view of a portion “a” shown in FIG. 5A, and FIG. 5C is an enlarged perspective view of the portion “a”.

As shown in FIG. 5A, when a width W2 of the card B is narrower than the connector insertion width W1 of the connector housing for card A (W1>W2), if the card B having terminals at a card end portion is inserted into the connector for card A having double-contact connector terminals, contact failures such as a short circuit and chattering between terminals occur in some cases.

FIGS. 5B and 5C show a state in which the card B is positionally shifted, so that connector terminals (power supply terminals VCC and VSS) for the same signal are positioned between two card terminals and the connector terminals for the same signal are in contact with the two card terminals. At this time, a short circuit occurs between the power supply terminals VCC and VSS. In a connector having double-contact (or plural-contact) power supply terminals with improved contact reliability in a power supply line, a contact failure due to a positional shift of the card (translation and rotational shift) becomes more pronounced.

FIG. 6 is a drawing showing an example of the occurrence of an electrical short circuit when a card C having terminals at a card rear end portion is reversely inserted into the connector housing for card A of the adaptor, in which FIG. 6A shows a state in which the card C is reversely inserted into the connector for card A, FIG. 6B is an enlarged plan view of a portion “a” shown in FIG. 6A, and FIG. 6C is an enlarged perspective view of the portion “a”.

As shown in FIG. 6A, when the card C having terminals at a card rear end portion is reversely inserted (as being rotated by 180 degrees), a short circuit occurs in some cases.

FIGS. 6B and 6C show a state in which the card C is positionally shifted, so that connector terminals (power supply terminals VCC and VSS) are positioned between two card terminals and one connector terminal is in contact with the two card terminals. At this time, a short circuit occurs between the power supply terminals VCC and VSS. Although only the power supply terminals VCC and VSS are shown in FIGS. 6B and 6C, this phenomenon similarly occurs not only for power supply terminals but also for signal terminals. Furthermore, although the case of the 180-degree rotation is shown in FIG. 6, a short circuit may occur even by the θ degree rotation.

<Second Problem>

Next, a second problem is a destruction of the connector terminals and a mechanical damage on the card at the time of the card insertion.

FIG. 7 is a drawing showing an example of the destruction of a connector terminal when the card is inserted into the connector housing of the adaptor, in which FIG. 7A is a side view of a thick card C1, FIG. 7B is a side view of a card C2 with a card thickness of 0.76 mm or smaller (hereinafter referred to as a thin card C2), FIG. 7C is a drawing showing a state before the thin card C2 is inserted into the connector housing, and FIG. 7D is a drawing showing a state after the thin card C2 is inserted into the connector housing.

As shown in FIG. 7A, in the case of the thick card C1 (when the value of tc1 is sufficiently large), a C surface and a fillet surface can be sufficiently chamfered (but tcc1<tc1). Here, the chamfer of the C surface means the chamfer of a card end portion, and the chamfer of the fillet surface means the local formation of an inclined surface.

However, according to the fact found from the experimental production this time, as shown in FIG. 7B, in the case of the thin card C2 (when the value of tc2 is small), a C surface and a filet surface with a height capable of guiding a contact terminal so as to be elastically deformed as desired cannot be formed (tcc2 to 0).

FIGS. 7C and 7D show a state of an insertion failure when a sufficient C surface is not formed. In FIGS. 7C and 7D, a lower portion of a connector is formed of a wiring substrate, plastic or others, and the fulcrum of the connector terminal is bonded or soldered to the lower portion of the connector. Also, t1 is a height of the card C surface from the bottom surface of the connector, and t2 is a height from the bottom surface of the connector to a tip of the connector terminal. When t2≧t1, the connector terminal hits a vertical end face higher than the height of the C surface of the card end portion, so that the connector terminal cannot be elastically deformed as desired and is destroyed. More specifically, when the thin card C2 with an insufficient C surface is inserted into the adaptor, a connector terminal is pressed while being hit at a card edge, and therefore, the connector contact point is destroyed due to the buckling of plastic deformation.

<Third Problem>

A third problem is inability of IC chip stacking in a thin card.

FIG. 8 is a cross-sectional view of a thin card having a plurality of IC chips mounted thereon and an adapter insertion port, in which FIG. 8A shows a case where IC chips are not stacked and FIG. 8B shows a case where a plurality of IC chips are stacked. In FIG. 8, the IC chips mounted in the card are schematically shown in the cross section and only the IC chips and a wiring substrate are shown, and the card outer shape is not shown for description. In FIG. 8, for example, the chip A is a flash memory chip and the chip B is a controller chip.

As shown in FIG. 8A, the thickness of the card capable of being inserted into the connector is restricted to be thinner than a height t_{c} of an insertion opening formed between an adaptor upper surface and an adaptor lower surface.

As shown in FIG. 8B, since the card having a plurality of IC chips stacked therein has a large sealing height and a card height is increased, the card cannot be inserted into the connector. To clarify the problem, the area of the chip B is shown so as to exceed a card insertion height in FIG. 8B. In practice, however, the sealing area (card outer shape) on the chip B cannot exceed t_{c}. More specifically, since the thickness of the thin card is restricted to a certain thickness to protect the chips, the insertion of the card becomes difficult due to the increase in thickness when the IC chips are stacked. This phenomenon becomes pronounced when the area of the chip A is increased so as to increase the capacity of the flash memory and the chip B is stacked on the chip A.

<Fourth Problem>

A fourth problem is the deflection of the thin card after being inserted into a connector.

FIG. 9 is a drawing showing an example of the deflection of a card, in which FIG. 9A is a plan view showing the outer shape of the card (terminal portions are represented by broken lines), FIG. 9B is a plan view showing the outer shape of the adaptor, FIG. 9C is a plan view showing the state where the card is inserted into the adaptor, FIG. 9D is a cross-sectional view of an A-A′ plane in FIG. 9B, FIG. 9E is a cross-sectional view of a B-B′ plane in FIG. 9C (case of a thick card), and FIG. 9F is a cross-sectional view of the B-B′ plane in FIG. 9C (case of a thin card).

The adaptor shown in FIG. 9B has a structure to retain the ends (guide portions) of the card. In FIG. 9C, broken lines represent the card end portion and connector terminal portions. In FIGS. 9E and 9F, portions indicated by triangular marks of broken lines represent card retainers (guide portions), that is, retaining fulcrums. In these figures, ta denotes the thickness of the card A and tb denotes the thickness of the card B, where the relation therebetween is tb<ta. The card B shown in FIG. 9F is the thin card B mountable into an IC card adaptor.

As shown in FIG. 9F, it can be understood that, when the thin card B is inserted into the adaptor, the card B is pressed up and deflected by the force of the contact terminals on the adaptor. In the case of a thick card, the stiffness of the entire card is high, and even when the fulcrums are positioned at the end portions, a large warping does not occur substantially with respect to the pressing force of the connector contact terminals applied to the entire card terminals. In the case of the thin card B shown in FIG. 9F, however, the card is largely deflected by the pressing force from the contact terminals with the retainers being at the end of the guide portions, and troubles are caused by the failures due to the insufficient electrical contact and the increase in total thickness including the adaptor and the deflected card.

<Fifth Problem>

A fifth problem is the restriction in the size of the mounted chip due to a direction-indicative notch provided at a corner of a card.

The card described in the fifth problem is not a thin card (card body) but a normal card.

FIG. 10 is a drawing showing an example of mounting an IC chip on a card, in which FIG. 10A is a plan view of a card (for example, miniUICC) having a chip A2 with a large width w mounted on a substrate, and FIG. 10B is a plan view of a card (for example, miniUICC) having a chip A3 with a large length l mounted on a substrate. The chip A2 is an IC chip with the large width w, and the chip A3 is an IC chip with the large length l. A corner notch indicates a card direction.

As shown in FIGS. 10A and 10B, in the shape having a notch in a part of a card such as miniUICC, the mounting area for rectangular chips and modules is restricted by the influence of the notch.

Although FIGS. 10A and 10B show a case in which the chip is smaller than the substrate, an exemplary case in which the chip can be made larger to have the same size as that of the substrate will be described below.

The size of the outer shape of the card is represented by a×b, and the lengths of the sides shortened due to the notch at a corner of the card are defined as L and W, respectively.

Due to the presence of the notch, the chip cannot be mounted on the card in the following range of the chip size.

That is, as is evident from the drawings, in the case of the chip A2 having a length l exceeding L (L<l<a) and a large width w, the chip cannot be mounted when W≦w≦b, and in the case of the chip A3 having a width w exceeding W (W<w<b) and a large length l, the chip cannot be mounted when L≦l≦a.

Further, also in a structure formed of a combination of the adaptor and the thin card (card body), since the adaptor has a notch because the outer shape of the card has a notch, the shape of the thin card is greatly restricted due to the notch.

The above and other objects and novel characteristics of the present invention will be apparent from the description of this specification and the accompanying drawings.

### Means for Solving the Problems

The typical ones of the inventions disclosed in this application will be briefly described based on embodiments as follows.

For the solution of the first problem, card terminals are arranged at the center of the card.

Also, according to another embodiment, for the solution of the second problem, a fulcrum (bonding point) of the connector terminals of the adaptor is directed to a card insertion port side of the adaptor.

Furthermore, according to still another embodiment, for the solution of the third problem, an increase in card thickness caused by stacking the chips is positioned at an insertion rear end of the card, thereby obtaining a card structure in which an insertion rear side of the card has a larger thickness than an insertion front side.

Still further, according to still another embodiment, for the solution of the fourth problem, a card is configured to have a structure in which a retaining structure is formed immediately above the contact terminals.

Still further, according to still another embodiment, for the solution of the fifth problem, the curvature of one of two corners of the card that is near a notch portion is made smaller than the curvature of the other corner having no notch.

### Effect of the Invention

The effects obtained by typical embodiments of the inventions disclosed in this application will be briefly described below.

(1) The occurrence of electrical short circuit between terminals can be reduced.

(2) The destruction of connector terminals of the adaptor when the card is inserted can be prevented.

(3) IC chips can be stacked even in a thin card.

(4) The deflection of the card due to the pressing force of the connector terminal when the card is inserted can be suppressed.

(5) The restriction of the area of the mounted chips and others due to the corner notch can be mitigated.

### BRIEF DESCRIPTION OF THE DRAWINGS

FIG. 1A is a block diagram showing the configuration of a smart card of Plug-in SIM (ID-000) examined as a premise of the present invention, and FIG. 1B is a drawing showing terminal allocation according to the ISO7816;

FIG. 2A is a structural drawing viewed from a SIC chip mounting side (opposite side of FIG. 1B) of the SIM card examined as a premise of the present invention, FIG. 2B is a cross sectional view along the line A-A′ of FIG. 2A, and FIG. 2C is a cross sectional view along the line B-B′ of FIG. 2A;

FIG. 3 is a drawing showing an insertion state of a card into a connector portion of an adaptor, in which FIG. 3A shows the state before insertion and FIG. 3B shows the state after insertion;

FIG. 4 is a drawing showing an example of the occurrence of an electrical short circuit when a card B having a narrow width is inserted into the connector housing for card A of the adaptor, in which FIG. 4A shows a state in which the card B is inserted into the connector for card A, FIG. 4B is an enlarged plan view of a portion “a” shown in FIG. 4A, and FIG. 4C is an enlarged perspective view of the portion “a”;

FIG. 5 is a drawing showing an example of the occurrence of an electrical short circuit when the card B with a narrow width is inserted into the connector having double-contact power supply terminals, in which FIG. 5A shows a state in which the card B is inserted into the connector for card A, FIG. 5B is an enlarged plan view of a portion “a” shown in FIG. 5A, and FIG. 5C is an enlarged perspective view of the portion “a”;

FIG. 6 is a drawing showing an example of the occurrence of an electrical short circuit when a card C having terminals at a card rear end portion is reversely inserted into the connector housing for card A of the adaptor, in which FIG. 6A shows a state in which the card C is reversely inserted into the connector for card A, FIG. 6B is an enlarged plan view of a portion “a” shown in FIG. 6A, and FIG. 6C is an enlarged perspective view of the portion “a”;

FIG. 7 is a drawing showing an example of the destruction of a connector terminal when the card is inserted into the connector housing of the adaptor, in which FIG. 7A is a side view of a thick card C1, FIG. 7B is a side view of a thin card C2, FIG. 7C is a drawing showing a state before the thin card C2 is inserted into the connector housing, and FIG. 7D is a drawing showing a state after the thin card C2 is inserted into the connector housing;

FIG. 8 is a cross-sectional view of a thin card having a plurality of IC chips mounted thereon and an adapter insertion port, in which FIG. 8A shows a case where IC chips are not stacked, and FIG. 8B shows a case where a plurality of IC chips are stacked;

FIG. 9 is a drawing showing an example of the deflection of a card, in which FIG. 9A is a plan view showing the outer shape of the card, FIG. 9B is a plan view showing the outer shape of the adaptor, FIG. 9C is a plan view showing the state where the card is inserted into the adaptor, FIG. 9D is a cross-sectional view of an A-A′ plane in FIG. 9B, FIG. 9E is a cross-sectional view of a B-B′ plane in FIG. 9C (case of a thick card), and FIG. 9F is a cross-sectional view of the B-B′ plane in FIG. 9C (case of a thin card);

FIG. 10 is a drawing showing an example of mounting IC chips on a card, in which FIG. 10A is a plan view of a card (miniUICC) having a chip A2 with a large width w mounted thereon, and FIG. 10B is a plan view of a card (miniUICC) having a chip A3 with a large length l mounted thereon;

FIG. 11 is a drawing showing an example of center arrangement of card terminals, in which FIG. 11A shows a case in which the card is normally inserted, FIG. 11B shows a case in which the card is reversely inserted, FIG. 11C shows a card terminal arrangeable region where a short circuit is not caused between the connector terminals and the card terminals, and FIG. 11D shows an example of the arrangement of the card terminals;

FIG. 12 is a drawing showing an example of center terminal arrangement with the terminals being located at a position separated by Z or more away from both sides, in which FIG. 12A shows a state when a card is normally inserted, and FIG. 12B shows a state when the card is reversely inserted;

FIG. 13 is a drawing showing an example of center arrangement of the card terminals at the time of normal, reverse, upper-side and lower-side insertions, in which FIG. 13A shows the outer shape of the card and the connector, FIG. 13B shows an example of the occurrence of a short circuit in the case of the card D, FIG. 13C shows a card terminal arrangeable region 1301 where a short circuit is not caused between connector terminals and card terminals, and FIG. 13D shows examples of the card terminal arrangement;

FIG. 14 is a drawing showing an example of preventing the destruction of a connector terminal at the time of card insertion, in which FIG. 14A shows the card dimension, FIG. 14B shows the state before the card insertion, and FIG. 14C shows the state after the card insertion;

FIGS. 15A, 15B and 15C are drawings showing card structures capable of stacking multiple chips;

FIG. 16 is a drawing showing an example of an adaptor structure and a card structure for suppressing the card deflection, in which FIG. 16A is a plan view showing the shape of the card, FIG. 16B is a plan view showing the adaptor structure according to the present invention, FIG. 16C is a drawing showing a state in which the card is inserted into the adaptor, FIG. 16D is a cross-sectional view of an A-A′ plane in FIG. 16B, and FIG. 16E is a cross-sectional view of a B-B′ plane in FIG. 16C;

FIG. 17 is a drawing showing the shape of a card mounted or inserted in a corner-notched card (adaptor) such as miniUICC;

FIG. 18 is a block diagram showing the configuration of an IC card according to an embodiment of the present invention;

FIG. 19 is a drawing showing an example of terminal signals of the thin memory card 1802;

FIG. 20A is a drawing showing an example of allocation of VCC terminals, and FIG. 20B is a drawing showing a timing chart;

FIG. 21 is a drawing showing an example of allocation of RSV (reserve) terminals;

FIG. 22 is a block diagram showing the configuration of the thin memory card 1802 in the first example (an example of a memory-stick interface);

FIG. 23 is a block diagram showing the configuration of the thin memory card 1802 in the second example (an example of a memory-stick interface);

FIG. 24 is a block diagram showing the configuration of the thin memory card 1802 in the third example (an example of a memory-stick interface);

FIG. 25 is a block diagram showing the configuration of the thin memory card 1802 in the fourth example (an example of a memory-stick interface);

FIG. 26 is a drawing showing the outer shape of the thin memory card 1802 according to an embodiment of the present invention, in which FIG. 26A is a plan view, FIG. 26B is a front view, FIG. 26C is a rear view, FIG. 26D is a left side view, FIG. 26E is a right side view, and FIG. 26F is a bottom view;

FIG. 27 is a perspective view showing the outer shape of the thin memory card 1802 according to an embodiment of the present invention, in which FIG. 27A is a drawing viewed from the top, and FIG. 27B is a drawing viewed from the bottom;

FIG. 28 is a drawing showing a mounting of chips in the thin memory card 1802 according to an embodiment of the present invention, in which FIG. 28A shows a basic example, FIG. 28B shows an applied example 1, and FIG. 28C shows an applied example 2;

FIG. 29 is a drawing showing a mounting of chips in the thin memory card 1802 according to an embodiment of the present invention, in which FIG. 29A shows an applied example 3, and FIG. 29B shows an applied example 4;

FIG. 30 is a drawing showing the outer shape of a Plug-in SIM conversion adaptor (SIM card adaptor 1801) according to an embodiment of the present invention, in which FIG. 30A is a plan view, FIG. 30B is a front view, FIG. 30C is a rear view, FIG. 30D is a left side view, FIG. 30E is a right side view, and FIG. 30F is a bottom view;

FIG. 31 is a perspective view showing the outer shape of the Plug-in SIM conversion adaptor (SIM card adaptor 1801) according to an embodiment of the present invention, in which FIG. 31A is a drawing viewed from the top, and FIG. 31B is a drawing viewed from the bottom;

FIG. 32 is a plan view showing the outer shape after the thin memory card 1802 is inserted into the Plug-in SIM conversion adaptor (SIM card adaptor 1801);

FIG. 33 is a longitudinal cross-sectional view showing the structure before and after the thin memory card 1802 is inserted into the Plug-in SIM conversion adaptor, in which FIG. 33A shows the state before the thin memory card 1802 is inserted, and FIG. 33B shows the state after the thin memory card 1802 is inserted;

FIG. 34 is a plan view showing a wiring structure of the Plug-in SIM conversion adaptor;

FIG. 35 is a cross-sectional view showing a wiring structure of the Plug-in SIM conversion adaptor;

FIG. 36 is a drawing showing the outer shape of a miniUICC adaptor (corresponding to the SIM card adaptor 1801) 3601 according to an embodiment of the present invention, in which FIG. 36A is a plan view, FIG. 36B is a front view, FIG. 36C is a rear view, FIG. 36D is a left side view, FIG. 36E is a right side view, and FIG. 36F is a bottom view;

FIG. 37 is a perspective view showing the outer shape of the miniUICC adaptor 3601 (corresponding to the SIM card adaptor 1801), in which FIG. 37A is a drawing viewed from the top, and FIG. 37B is a drawing viewed from the bottom;

FIG. 38 is a drawing showing an outer-shape conversion adaptor 1 (M2 adaptor) for thin memory card and an internal connection of the M2 adaptor according to an embodiment of the present invention, in which FIG. 38A is a drawing showing the thin memory card 1802, FIG. 38B is a drawing showing a conversion adaptor 3801, FIG. 38C is a cross-sectional view showing the conversion adaptor 3801 before the card insertion, and FIG. 38D is a cross-sectional view showing the conversion adaptor 3801 after the card insertion;

FIG. 39 is a drawing showing an outer shape of the outer-shape conversion adaptor 1 (M2 adaptor) for thin memory card, in which FIG. 39A is a plan view, FIG. 39B is a bottom view, and FIG. 39C is a side view;

FIG. 40 is a drawing showing an outer-shape conversion adaptor 2 (M2 adaptor) for thin memory card and an internal connection of the M2 adaptor according to an embodiment of the present invention, in which FIG. 40A is a drawing showing the thin memory card 1802, FIG. 40B is a drawing showing the conversion adaptor 3801, FIG. 40C is a cross-sectional view showing the conversion adaptor 3801 before the card insertion, and FIG. 40D is a cross-sectional view showing the conversion adaptor 3801 after the card insertion;

FIG. 41 is a drawing showing the outer shape of a SIM-function-equipped thin memory card 2 according to an embodiment of the present invention, in which FIG. 41A is a plan view, FIG. 41B is a front view, FIG. 41C is a rear view, FIG. 41D is a left side view, FIG. 41E is a right side view, and FIG. 41F is a bottom view;

FIG. 42 is a drawing showing an example of card terminal arrangement of the SIM-function-equipped thin memory card 2 (an example of MS I/F+ISO 7816 I/F);

FIG. 43 is a drawing showing an example of allocation of VCC terminals;

FIG. 44 is a drawing showing an example of allocation of RSV (reserve) terminals;

FIG. 45 is a drawing showing an example of allocation of RSV (reserve) terminals;

FIG. 46 is a drawing showing the outer shape of a Plug-in SIM conversion adaptor 2 (SIM card adaptor 1801) according to an embodiment of the present invention, in which FIG. 46A is a plan view, FIG. 46B is a front view, FIG. 46C is a rear view, FIG. 46D is a left side view, FIG. 46E is a right side view, and FIG. 46F is a bottom view;

FIG. 47 is a plan view showing the outer shape after the thin memory card 1802 is inserted into the Plug-in SIM conversion adaptor (SIM card adaptor 1801);

FIG. 48 is a longitudinal cross-sectional view showing the structure before and after the thin memory card 1802 is inserted into the Plug-in SIM conversion adaptor 2, in which FIG. 48A shows the state before the thin memory card 1802 is inserted, and FIG. 48B shows the state after the thin memory card 1802 is inserted;

FIG. 49 is a drawing showing the outer shape of a miniUICC adaptor 2 (corresponding to the SIM card adaptor 1801) according to an embodiment of the present invention, in which FIG. 49A is a plan view, FIG. 49B is a front view, FIG. 49C is a rear view, FIG. 49D is a left side view, FIG. 49E is a right side view, and FIG. 49F is a bottom view;

FIG. 50 is a perspective view showing the outer shape of the miniUICC adaptor 2, in which FIG. 50A is a drawing viewed from the top, and FIG. 50B is a drawing viewed from the bottom;

FIG. 51 is a drawing showing the outer shape of a thin memory card 3 with notch according to an embodiment of the present invention, in which FIG. 51A is a plan view, FIG. 51B is a front view, FIG. 51C is a rear view, FIG. 51D is a left side view, FIG. 51E is a right side view, and FIG. 51F is a bottom view;

FIG. 52 is a drawing showing the outer shape of a thin memory card 4 with notch according to an embodiment of the present invention, in which FIG. 52A is a plan view, FIG. 52B is a front view, FIG. 52C is a rear view, FIG. 52D is a left side view, FIG. 52E is a right side view, and FIG. 52F is a bottom view;

FIGS. 53A and 53B are drawings showing examples of center arrangement of the card terminals; and

FIG. 54 is a drawing showing an example of center arrangement of the card terminals.

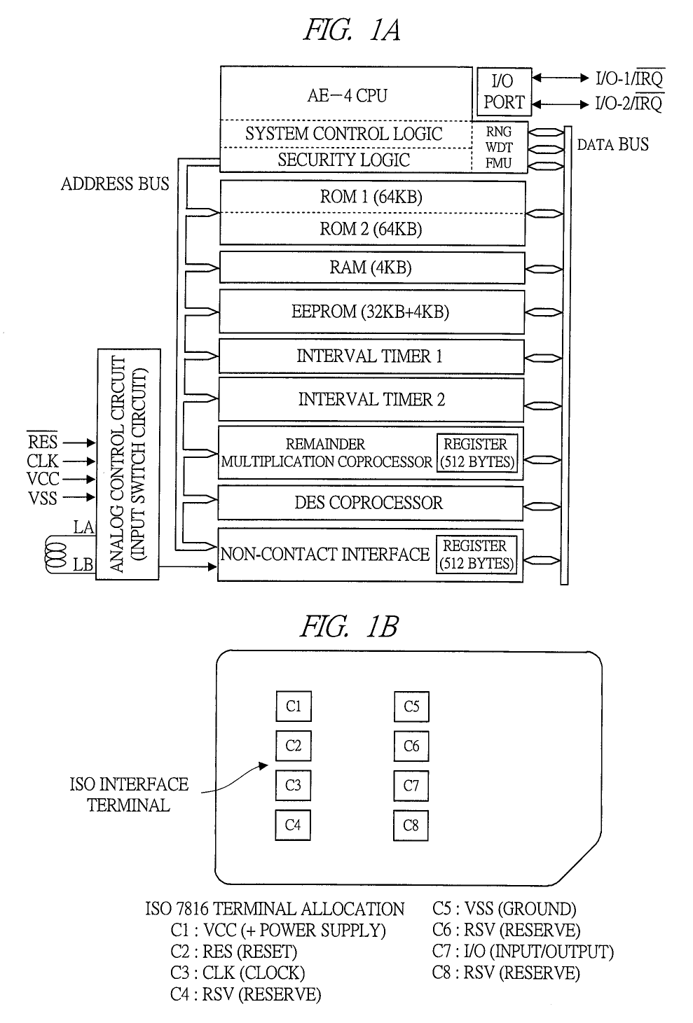

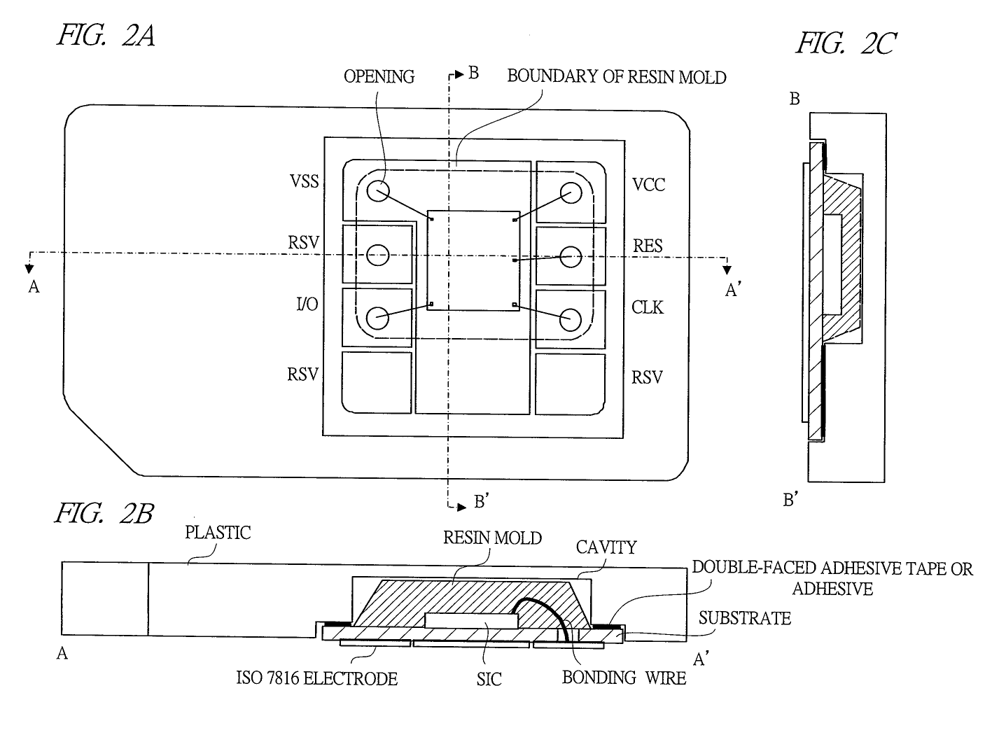

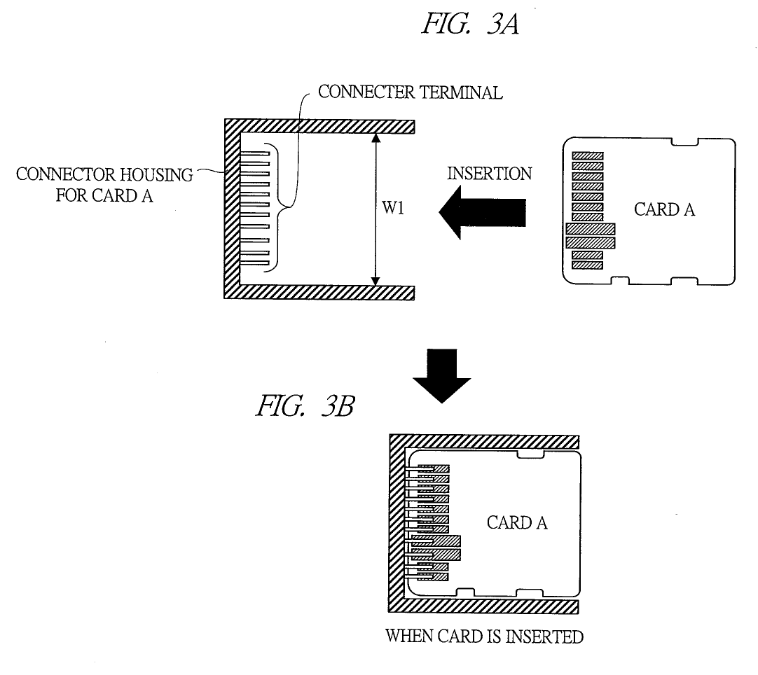

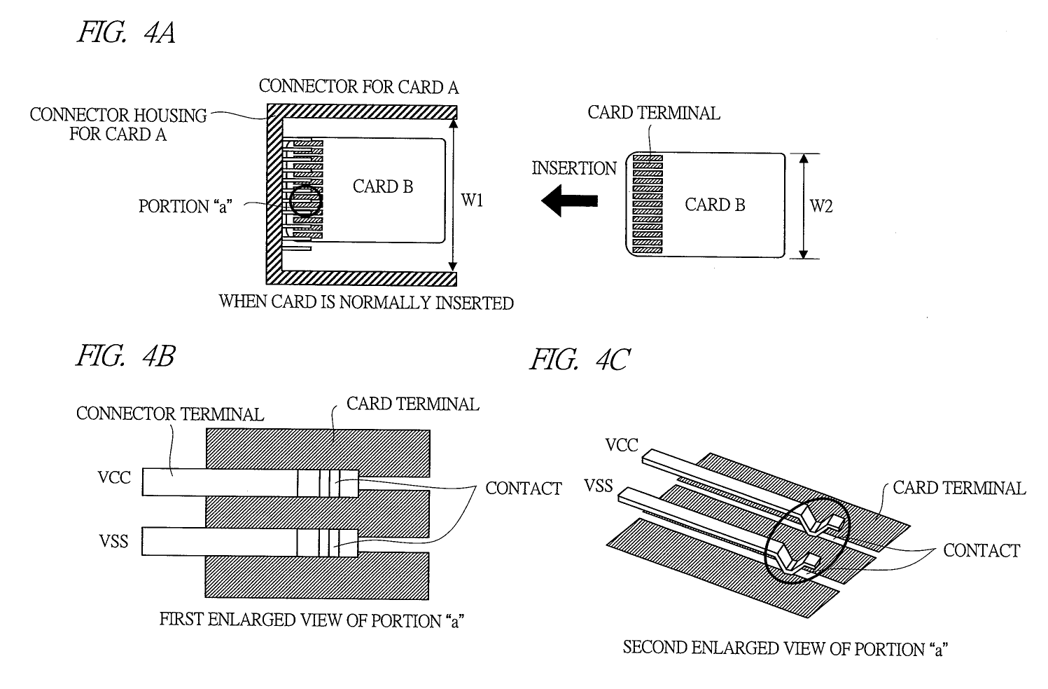

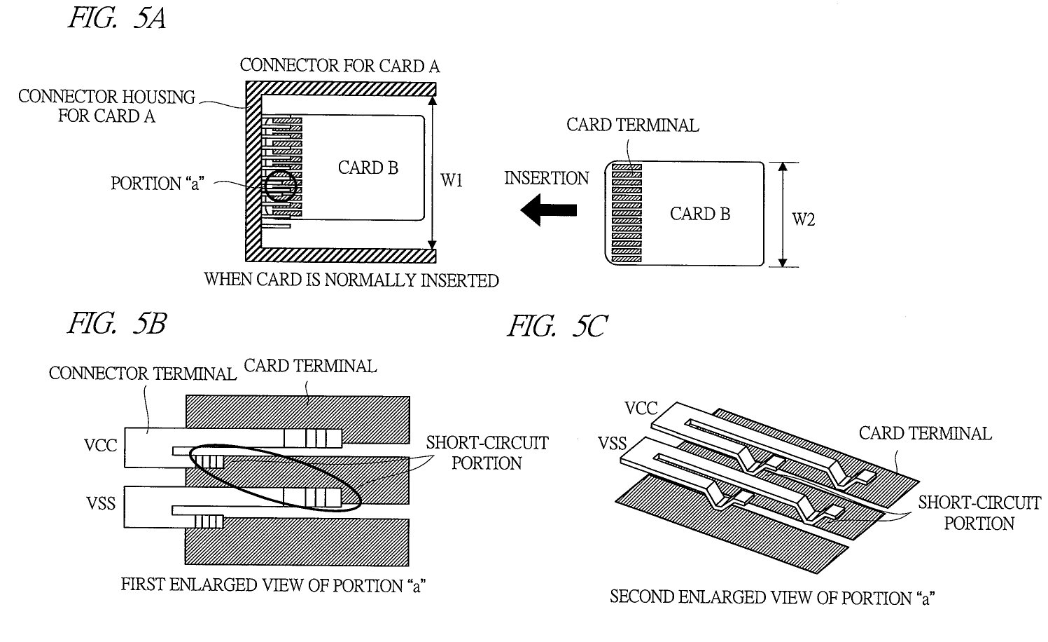

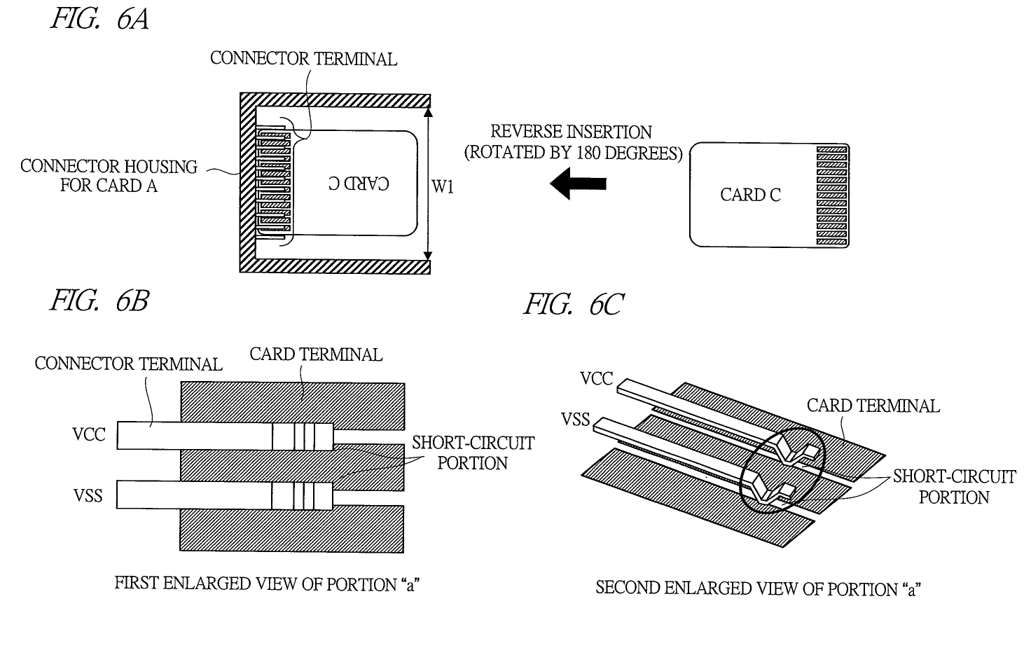

### BEST MODE FOR CARRYING OUT THE INVENTION

Hereinafter, embodiments of the present invention will be described in detail with reference to the accompanying drawings. Note that components having the same function are denoted by the same reference numbers throughout the drawings for describing the embodiments, and the repetitive description thereof will be omitted.

### First Embodiment

The first embodiment mainly shows the solution for the first problem. In short, card terminals are arranged at the center of a card that is a semiconductor device (the semiconductor device is hereinafter referred to as a card or a thin card).

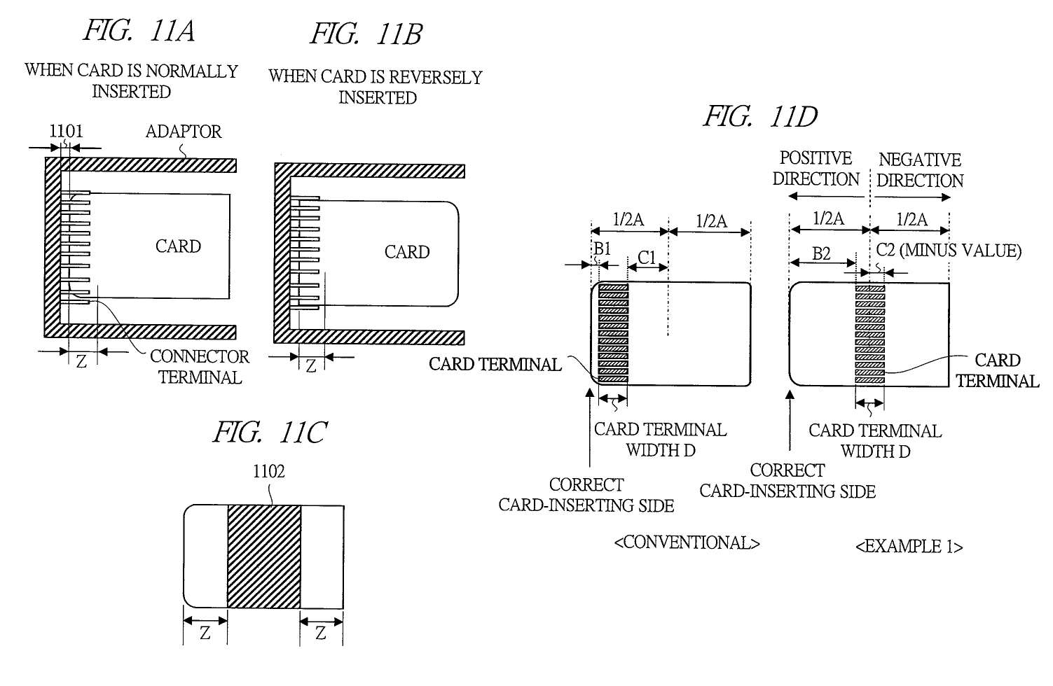

FIGS. 11, 53 and 54 show a card having card terminals arranged at the center of the card and an adaptor having connector terminals electrically connectable to the card terminals of the card when the card is inserted into the adaptor.

Note that the adaptor mentioned here is the adaptor for another card, and it is not supposed to be used with the card shown here being inserted thereinto.

FIG. 11A shows a case in which the card is normally inserted, FIG. 11B shows a case in which the card is reversely inserted, FIG. 11C shows a card terminal arrangeable region where a short circuit is never or hardly caused between the connector terminals and the card terminals, and FIG. 11D shows an example of the arrangement of the card terminals.

In FIG. 11A, 1101 denotes a stroke region of the so-called Push-Push connector where the card is slid and discharged when the card is pressed. In FIGS. 11A, 11B and 11C, Z denotes a region where the card is slid by the connector terminals. In FIG. 11C, a hatched portion denoted by 1102 is a card terminal arrangeable region where the connector terminals and the card terminals do not cause a short circuit. The card terminals are arranged in this region.

Note that, although Z in FIG. 11C changes depending on the adaptor size and the card size, the occurrence of a short circuit can be reduced by providing the card terminals in the center region 1102 instead of the regions at both ends of the card.

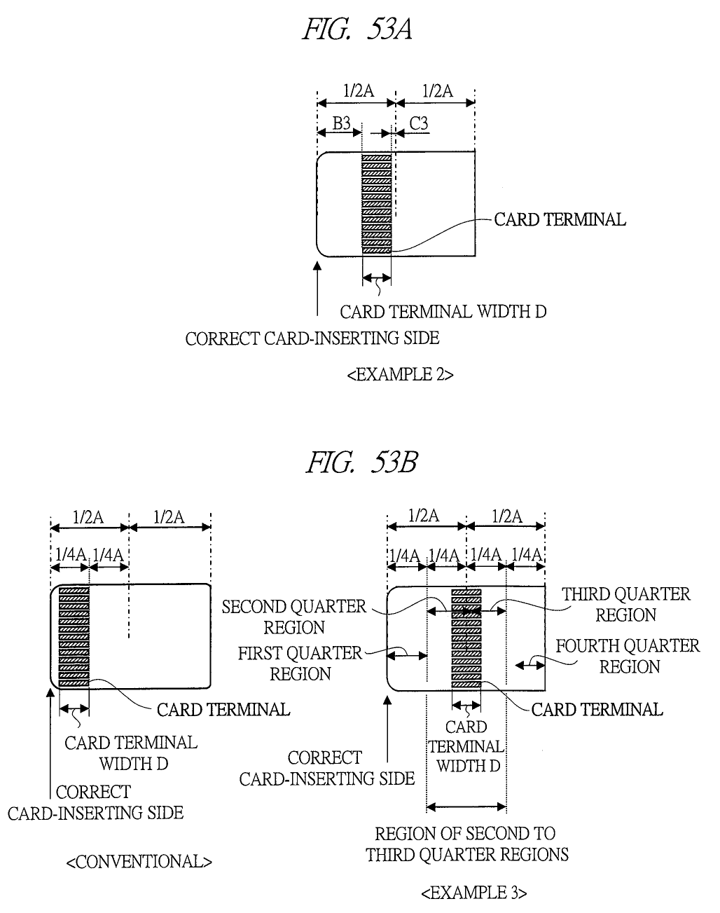

The card terminals positioned in the center region can be shown in, for example, FIGS. 11D, 53A and 53B.

In FIG. 11D, the card terminals are conventionally positioned so that a distance B1 from one side of the card on a correct card-inserting side to one end of the card terminals is shorter than a distance C1 from an intermediate position in a longitudinal direction of the card to the other end of the card terminals.

By contrast, in the present embodiment, the card terminals are positioned so that a distance B2 from one side of the card on a correct card-inserting side to one end of the card terminals is longer than a distance C2 from an intermediate position in a longitudinal direction of the card to the other end of the card terminals. Note that, since a direction from the intermediate position of the card toward one side of the card on a card-inserting side is taken as a positive direction and a reverse direction thereof is taken as a negative direction, the distance C2 has a minus value.

FIG. 53A shows an example in which the card terminals are shifted from the center position and C3 has a positive value.

Even in this case, B3 is larger than C3, so that the problem of a short circuit can be suppressed.

FIG. 53B shows the cards each having the card terminals located in different positions. In each case, the card is divided into four regions in a longitudinal direction of the card, and the position of the card terminals on the card is illustrated. In a conventional example, the card terminals are located within the first quarter region from one side of the card on a correct card-inserting side. The card terminals are located within the second and third quarter regions thereof in the example 3.

With the card terminals being located at the position described above, the occurrence of a short circuit can be more suppressed.

There may be the case in which the card terminals do not fit in each of the quarter regions when the card terminals are long or the position is adjusted. However, if a ratio of the area of the card terminals occupying the second and third quarter regions is higher than that occupying other regions, the occurrence of a short circuit can be reduced compared with the case where the ratio occupying other regions is high.

Here, as an example of specific numerical values, the length of the card terminals in a longitudinal direction is about 1 cm to 2 cm, and the length of the card terminals in a direction orthogonal to the longitudinal direction is about 2 mm to 4 mm.

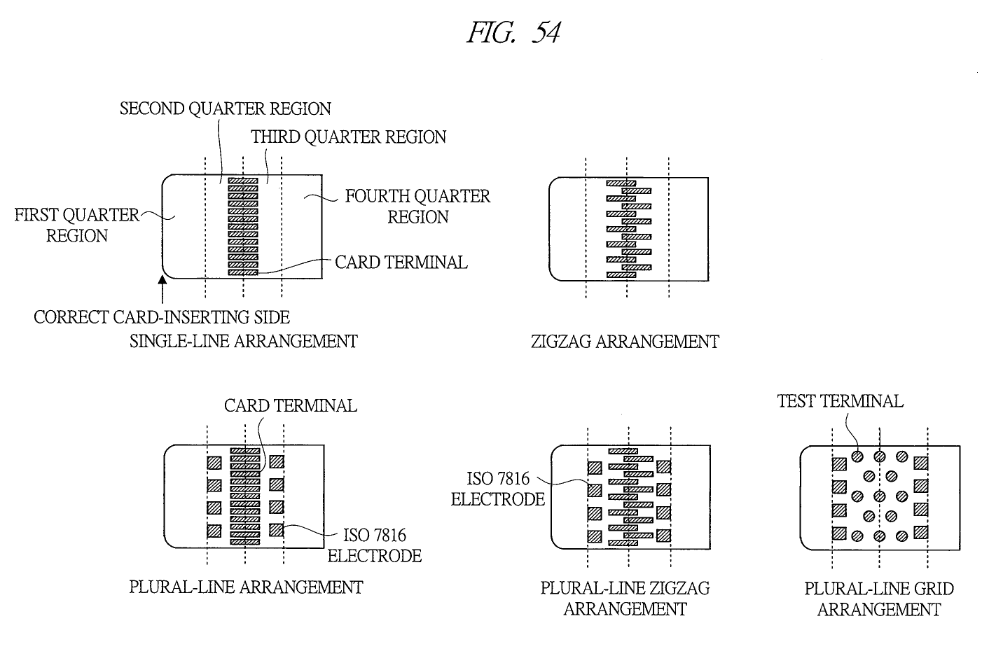

FIG. 54 shows examples of the single-line arrangement in which the card terminals are arranged in a line, the zigzag arrangement in which the card terminals are arranged in a repeated pattern so as to be shifted one by one, the plural-line arrangement in which ISO 7816 terminals and the card terminals are arranged in lines, the plural-line zigzag arrangement in which the zigzag arrangement and the plural-line arrangement are mixed together, and the plural-line grid arrangement in which grid terminals to be test terminals which are the measuring terminals of the voltage and signal inside the card and the card terminals are arranged together.

Broken lines on each card represent the lines for dividing the card into four quarter regions like FIG. 53B.

It can be said from these arrangements that the card terminals and other terminals are provided in the second and third quarter regions. From another point of view, the area ratio of terminals such as the card terminals occupying the second and third quarter regions is higher than the area ratio of the terminals occupying the first quarter region.

From still another point of view, it can be said that the density of the terminals in the second and third quarter regions is higher than the density of the terminals in the first quarter region.

Note that the fourth quarter region may be similar to the first quarter region.

By setting the area ratio of the terminals or the density of the terminals in the manner described above, the problem of a short circuit can be suppressed ever before.

Since the ISO 7816 electrodes are terminals defined by standards, they are not restricted by the region arrangement described above, and the structure in which only the card terminals satisfy the above-described requirements is also possible.

This is because at least the problem of a short circuit of the card terminals can be suppressed even in this structure.

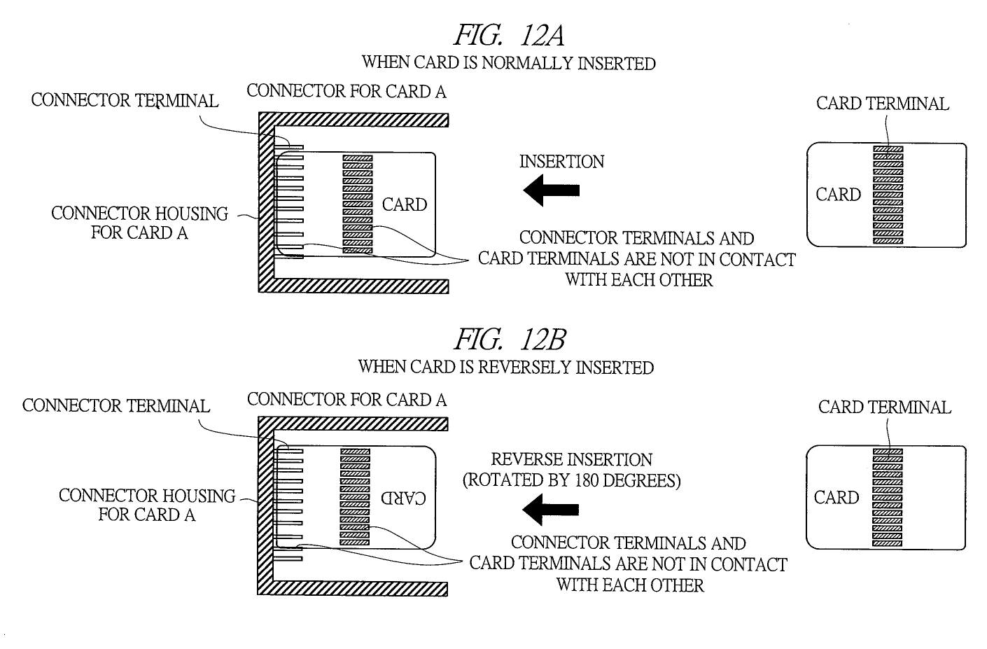

FIG. 12 is a drawing showing an example of center terminal arrangement with the terminals being located at a position separated by Z or more away from both sides, in which FIG. 12A shows a state when a card is normally inserted, and FIG. 12B shows a state when the card is reversely inserted.

As shown in FIGS. 12A and 12B, when the terminals are arranged at the center, the card terminals and the connector terminals are hard to cause a short circuit (contact) in both of the normal insertion and the reverse insertion.

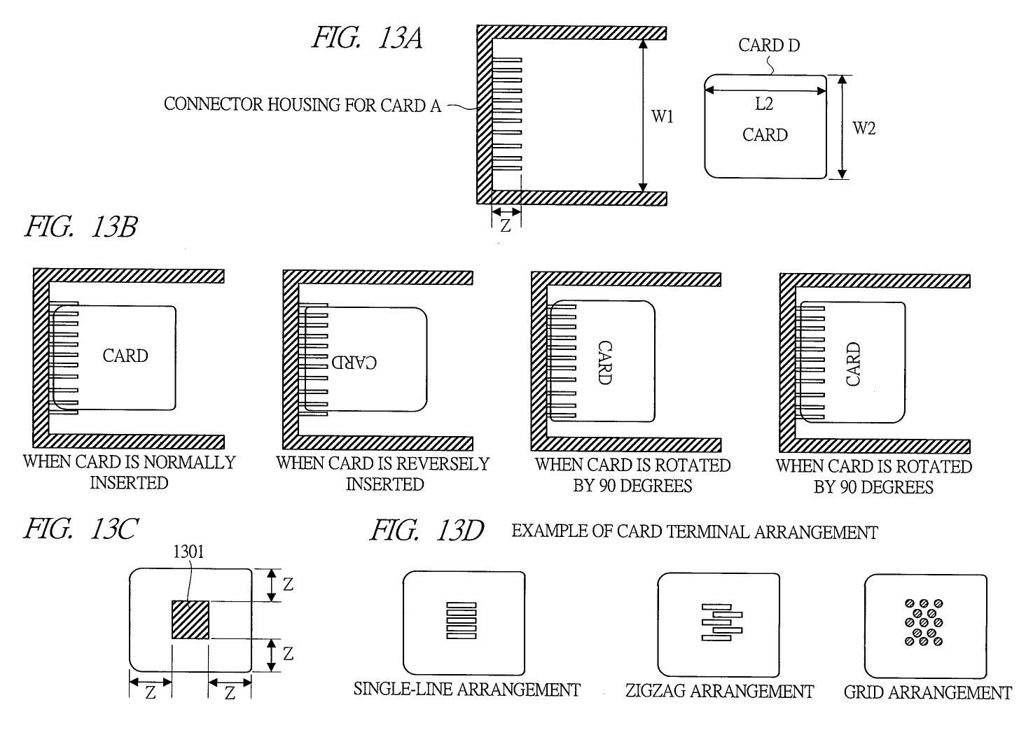

FIG. 13 is a drawing showing an example of center arrangement of the card terminals at the time of normal, reverse, upper-side and lower-side insertions, in which FIG. 13A shows the outer shape of the card and the connector, FIG. 13B shows an example when a card D is inserted normally, reversely, after rotated in a clockwise direction by 90 degrees, and after rotated in a counterclockwise direction by degrees, respectively, FIG. 13C shows a card terminal arrangeable region 1301 where a short circuit is hard to occur between connector terminals and card terminals, and FIG. 13D shows examples of the card terminal arrangement.

The case in which the width and length of the card are both smaller than a connector insertion width W1 as shown in FIG. 13A, that is, W1 (connector for card A)>L2 and W1 (connector for card A)>W2 will be considered. In this case, as shown in FIG. 13B, a short circuit may occur when the card is normally inserted, when the card is reversely inserted, and the card is rotated by 90 degrees. As the solution for this case, the card terminals are arranged in the card terminal arrangeable region 1301 where a short circuit is hard to occur between connector terminals and card terminals as shown in FIG. 13C. FIG. 13D shows the single-line arrangement, the zigzag arrangement and the grid arrangement as examples of the card terminal arrangement. Examples to suppress the occurrence of a short circuit between power supplies and signals in a card erroneously inserted into an unsuitable connector have been shown above. Depending on the card, however, the center arrangement is not necessarily applied to all terminals on the card. For example, only terminals that are important in the detection of the card and terminals inducing a latch-up failure in operation such as data terminals where data is input and output, control terminals in which a control signal for controlling the operation of the card is input, and clock terminals in which a clock signal is input are emphasized and restrictively arranged at the center.

Further, among these terminals, the center arrangement may be applied to those through which an abnormal current possibly flows due to latch-up caused by the contact between the connector terminals and the card terminals before the card is powered on.

Also, reverse insertion can be prohibited by forming the card to have a certain exclusive structure with respect to the adaptor. However, for example, since a problem as to whether this exclusive structure is applied to another adaptor may occur, the restriction by Z from the card rear end may be provided even in these cases.

As described above, according to the first embodiment, the card terminals are arranged at the center of the card.

Alternatively, the distance from one side of the card on a correct card-inserting side to one end of the card terminals is made longer than the distance from an intermediate position of the card in the longitudinal direction to the other end of the card terminals.

Alternatively, when the card is equally divided into four regions in the longitudinal direction of the card, the card terminals are provided in the second and third quarter regions from one side of the card on the correct card-inserting side.

Alternatively, the area ratio of the card terminals occupying the second or third quarter region is made higher than that occupying the first quarter region.

Alternatively, the density of the card terminals in the second or third quarter region is made higher than that in the first quarter region.

In this manner, the occurrence of a short circuit between power supplies and signals can be more suppressed in the card erroneously inserted into the adaptor.

### Second Embodiment

The second embodiment mainly shows the solution for the second problem. In short, a fulcrum (bonding point) of the connector terminals of the adaptor is directed to a card insertion port side of the adaptor.

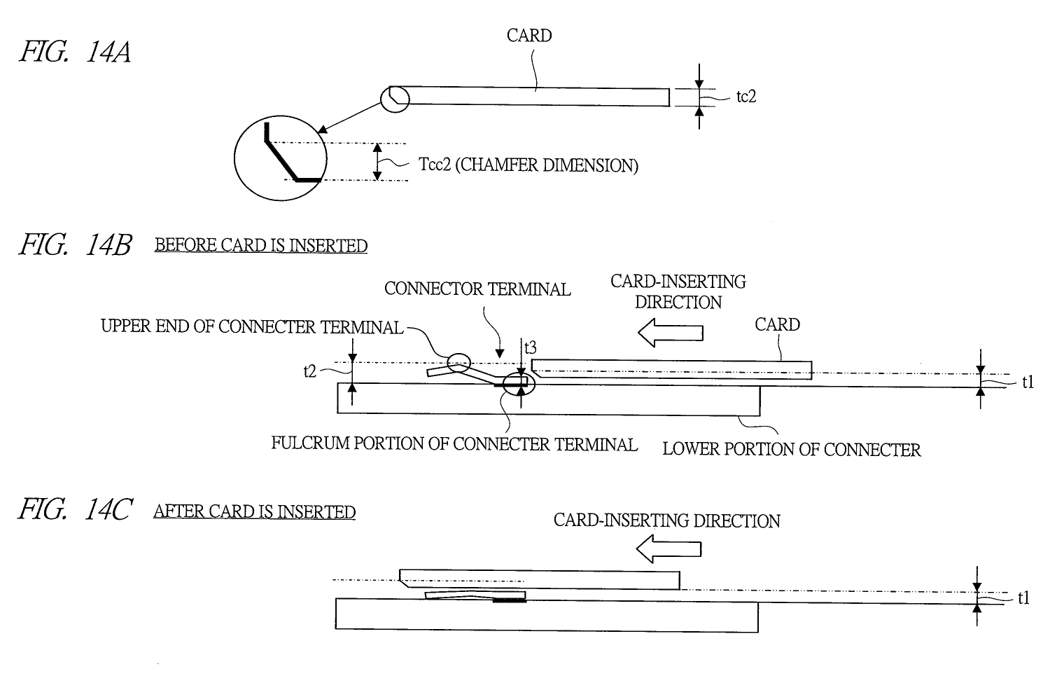

FIG. 14 is a drawing showing an example of preventing the destruction of a connector terminal at the time of card insertion, in which FIG. 14A is a drawing showing a chamfer dimension (height of the card C surface) tcc2 indicative of the height of the chamfer portion of the card and a card thickness tc2, FIG. 14B is a drawing showing a positional relation between the card and the connector terminal before the card insertion, and FIG. 14C is a drawing showing the state after the card insertion. In FIG. 14, t1 denotes a height from the surface of a lower portion of the connector on a card insertion side to the card C surface, t2 denotes a distance between an upper end of the connector terminal and the surface of the lower portion of the connector on the card insertion side, and t3 denotes a height of a fulcrum portion of the connector terminal. The t1 is a sum of a space dimension between the card and the connector and the chamfer dimension tcc2. The fulcrum is bonded or soldered to the lower portion of the connector. The lower portion of the connector is formed of a wiring substrate, plastic, or others.

A solution for a buckling failure of the connector terminal when tcc2 is 0 or extremely small is as follows. If the connector-fixed position (for example, the fulcrum) is set on a front side with respect to a connector terminal contact position in a card-inserting direction, under a condition in which a failure that the height position of the fulcrum is not in contact with the card does not occur (a space between the card and the connector is larger than the thickness of the fulcrum portion of the connector terminal so that the card and connector terminal do not collide with each other), the connector terminal is not buckled. At this time, the card chamfer tcc2 can be 0. Further, in view of the repeated insertion and removal, deformation of the connector terminal after the card insertion is desirably designed so as to be within a range of elastic deformation. The reason why the connector terminal is not buckled even without the C surface is that the fulcrum of the connector terminal is present below the bottom of the card, that is, at the lower portion of the connector and the connector terminal can thus be deformed as designed so as to always follow the card insertion.

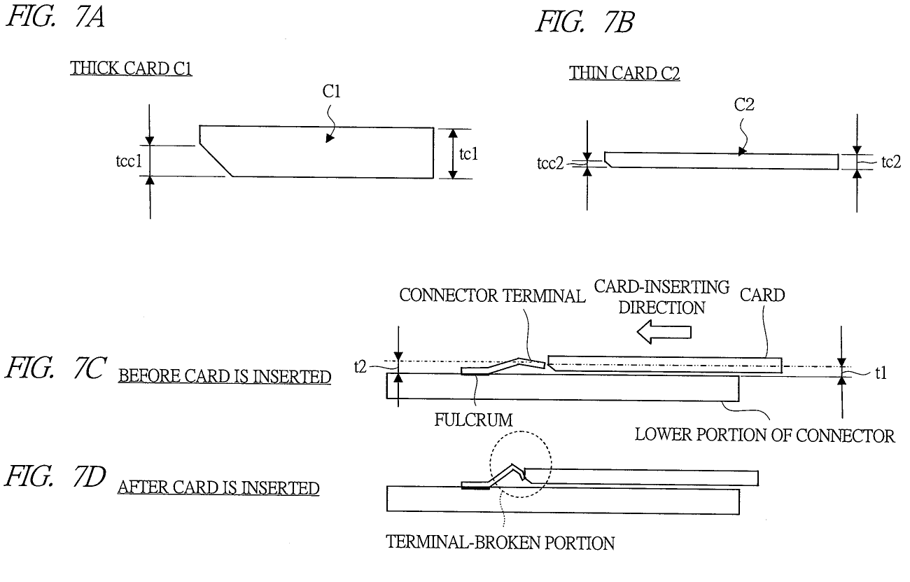

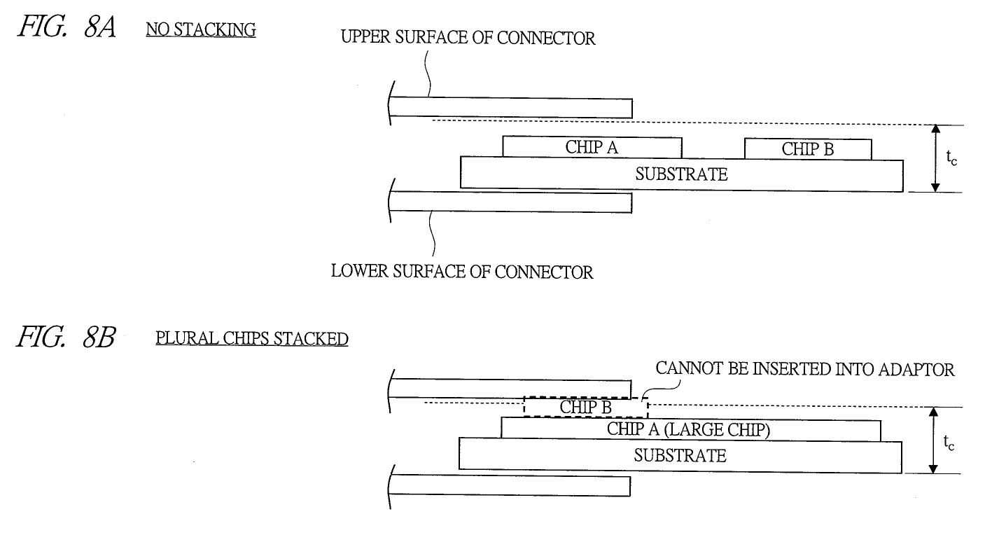

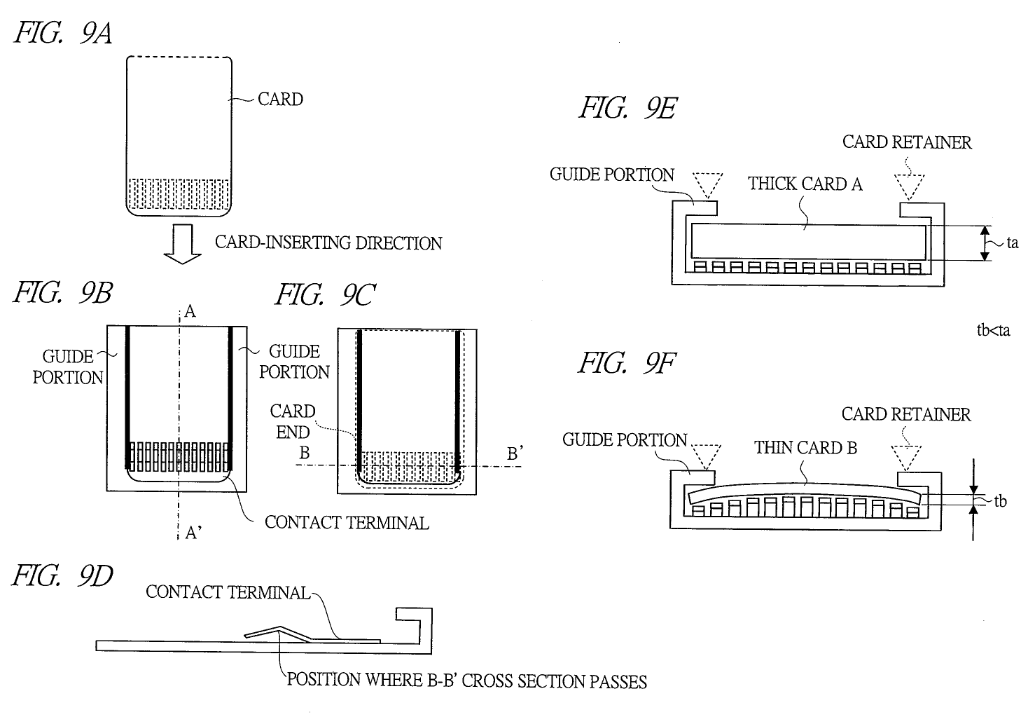

Also, another difference from FIG. 7 is as follows. That is, in FIG. 7, a side near the card insertion port is taken as a tip of the connector terminal and a side away from the card insertion port is taken as a fulcrum portion of the connector terminal. By contrast, in FIG. 14B, the side near the card insertion port is taken as a fulcrum portion of the connector terminal, and a side away from the card insertion port is taken as a tip of the connector terminal.

As shown in FIG. 14, since the card moves from the fixed fulcrum portion of the connector terminal toward the movable tip of the connector terminal when the card is inserted, it is possible to prevent the tip of the connector terminal from colliding with the card.

As described above, according to the second embodiment, since the fulcrum of the connector terminal of the adaptor is provided below the bottom surface of the card, the destruction of the connector terminal of the adaptor at the time of the card insertion can be prevented.

### Third Embodiment

The third embodiment mainly shows the solution for the third problem. In short, an increase in card thickness due to the stacked chips is positioned at an insertion rear end of the card, thereby forming a partially-thick card structure.

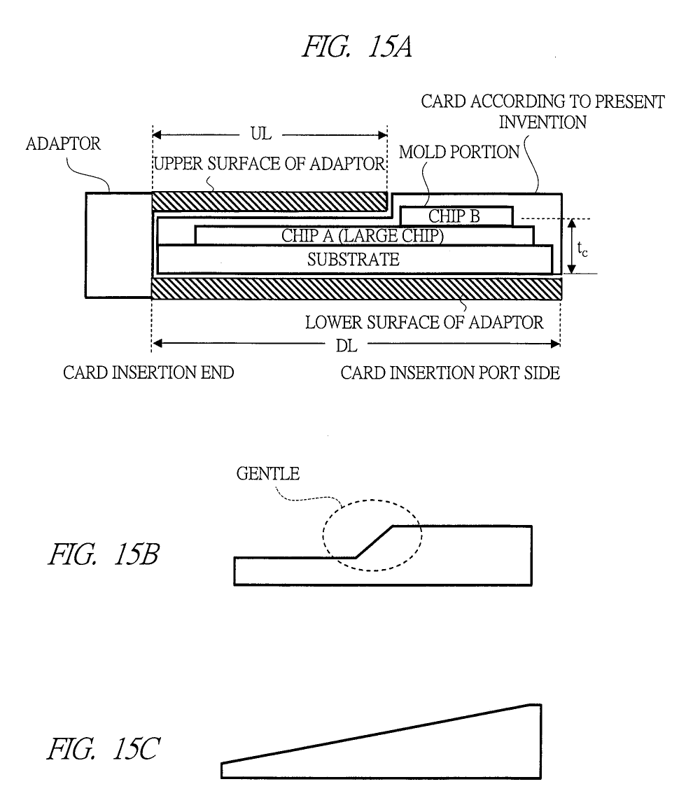

FIG. 15 is a drawing showing a card structure capable of stacking multiple chips. In FIG. 15, for example, a chip A is a flash memory chip with a large chip size mounted on a wiring substrate, and a chip B is a controller chip for controlling the flash memory. The controller chip is smaller in chip size than the flash memory.

The entire card is covered with a mold portion made of plastic resin or the like for protecting the chip surface. The t_{c} denotes a maximum thickness of a card insertable into the adaptor. As shown in FIG. 15, the card is configured to have a two-step structure with two thicknesses, and a chip-stacked portion is positioned at the insertion read end. By this means, the lower and upper portions of the connector guide or retain the card by a thin portion of the card, and a thick portion (in FIG. 15A, a portion where the chip B is mounted) of the card is exposed. This exposed portion of the card can be drawn from the connector as a portion directly handled when the card is inserted or removed. Also, a marking for card recognition can be typed or printed to this thick exposed portion.

Also, the size of the controller chip is equal to or smaller than half the size of the substrate. For this reason, the planar area of the thick portion of the card is narrower than the planar area of the thin portion of the card. Accordingly, the amount to be inserted into the connector is increased, so that the stability after the insertion is enhanced.

Note that, even when the size of the controller chip is larger than half the size of the substrate, this two-step structure is applicable as long as the chip size is smaller than the flash memory.

Furthermore, although the case of two chips is taken as an example in FIG. 15A, the card may have a stepwise thickness structure with two steps by combining three or more chips or a stepwise multi-step structure with three or more steps.

Still further, a semiconductor chip to be mounted on the card is not restricted to a flash memory chip and a controller chip, and a chip having another function such as DRAM, SRAM or microcomputer may be mounted.

Still further, although a boundary between the thick portion and the thin portion of the card is approximately vertical in FIG. 15A, the thick portion and the thin portion may continue in a gentle slope as shown in FIGS. 15B and 15C.

The shape of the adaptor may be changed accordingly.

Although the multi-step structure of the card has been described, a new structure is applied also to the adaptor.

As shown in FIG. 15, the length from the card insertion end to the card insertion port of the upper surface of the adaptor is shorter than that of the lower surface of the adaptor (UL<DL).

In this manner, the insertion of the card with a multi-step structure can be achieved.

As described above, according to the third embodiment, the card is configured so that the thickness of the card is gradually increased as going from a card insertion side to an insertion rear side, so that IC chips can be stacked on a card whose card thickness is restricted due to the problem of the height of the insertion port of the adaptor.

### Fourth Embodiment

The fourth embodiment mainly shows the solution for the fourth problem. In short, the card is configured to have a retainer structure immediately above the contact terminals.

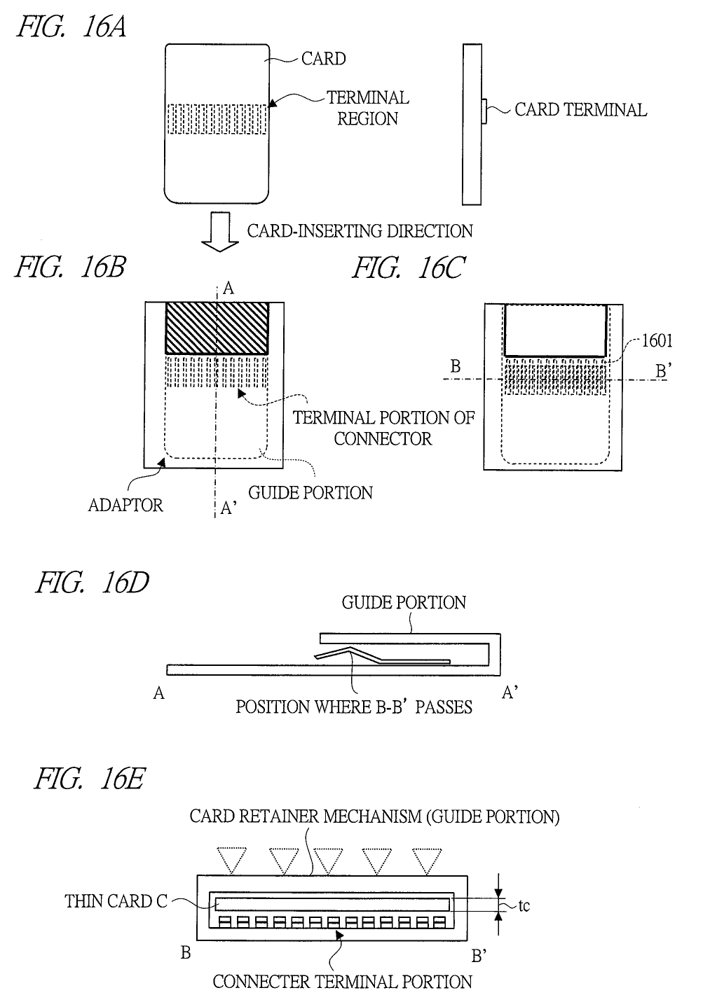

FIG. 16 is a drawing showing an example of an adaptor structure and a card structure for suppressing the card deflection, in which FIG. 16A is a plan view showing the shape of the card and a region of the card terminals on a bottom surface and a side view of the card viewed from a right side, FIG. 16B is a plan view showing the adaptor structure according to the present invention, FIG. 16C is a drawing showing a state in which the card is inserted into the adaptor, FIG. 16D is a cross-sectional view of an A-A′ plane in FIG. 16B, and FIG. 16E is a cross-sectional view of a B-B′ plane in FIG. 16C.

As shown in FIG. 16B, the adaptor has a plate-shaped structure in which an upper surface portion of the adaptor is formed except a hatched region. Here, the upper surface portion of the adaptor planarly overlapped with the card is taken as a guide portion. The guide portion covers a connector terminal portion in which a plurality of terminals are arranged. In FIG. 16C, 1601 denotes a state where the connector terminal portion is in contact with the card terminal portion. As shown in FIG. 16E, a guide portion which is an upper surface portion of the adaptor is provided so as to face each connecter terminal. Therefore, the guide portion acts as a card retainer mechanism with a plurality of fulcrums (triangular marks of broken lines in the drawing roughly represent fulcrums for the sake of convenience, but such fulcrums do not appear in practice).

By this means, since the pressing force to the card from the contact terminals is supported by the entire guide portion in an evenly distributed manner, deflection of the card can be suppressed.

Also in this case, since the plate of this retainer structure positioned on an upper portion of the card is mechanically connected to the side surfaces of the adaptor, the in-plane tension can be successively transmitted. Therefore, it is also possible to generate a repulsive or position-retaining force of the pressing force from the connector terminals.

Although a plate-shaped portion is taken as an example of the guide portion here, the guide portion may be provided with a retainer structure for restricting the deflection of the card immediately above the connector terminal contact portion or near the immediately-above position so as to suppress or reduce the amount of card deflection due to the pressing force from the connector terminals to the card. For example, the guide portion may be provided with a plurality of holes and slits. That is, the in-plane tension of the plate structure can be transmitted even when the plate is partially opened.

The present embodiment can be applied to the exemplary card with the multi-step structure described in the third embodiment by arranging the card terminals to be in contact with the connector terminals in the thin card region. At this time, it does not matter as long as the retainer plate (guide portion) of the upper portion of the card covers at least a card terminal portion in the thin card region.

As described above, according to the fourth embodiment, since the guide portion which is an upper surface portion of the adaptor is provided so as to cover the connector terminal portion of the adaptor, the deflection of the card at the time of the card insertion can be suppressed.

### Fifth Embodiment

The fifth embodiment mainly shows the solution for the fifth problem. In short, the curvature of a corner portion of the card at a portion having no notch is made lager than that of a notch portion.

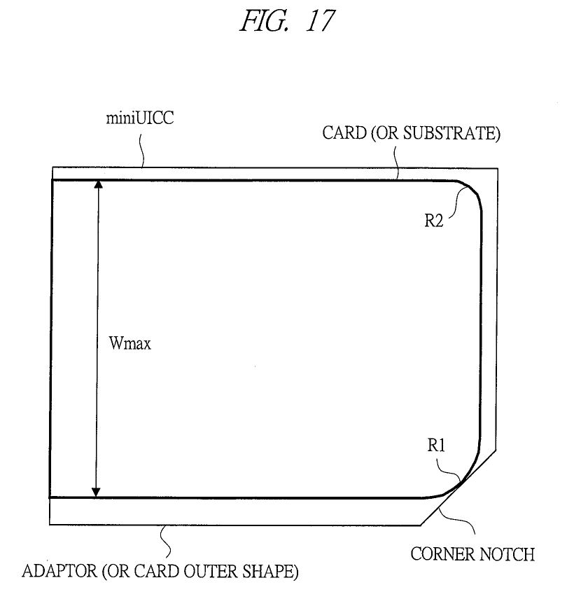

FIG. 17 exemplarily shows the shape of a substrate having chips mounted thereon in a card having a corner notch such as miniUICC or the shape of a card to be inserted into the adaptor.

In consideration of the mounting of a substrate in a card having a corner notch such as miniUICC or the insertion of a thin card, the shape of the tip of the substrate or the card is chamfered so that corner portions are rounded as shown in FIG. 17. The thin card inserted into miniUICC has a corner R1 in contact with the notch or within the maximum values of standards for the outer shape of the miniUICC card. By this means, the area of the thin card or the chip-mounted area can be increased. Here, it is assumed that R1>R2. With respect to the curvature, the curvature on an R2 side is larger than that on an R1 side. R1 is set so as not to exceed the corner notch. Although the corner has an arc shape in FIG. 17, the corner can be deformed into any straight-line or polygonal shape or deformed by the combination thereof within the scope of the present invention.

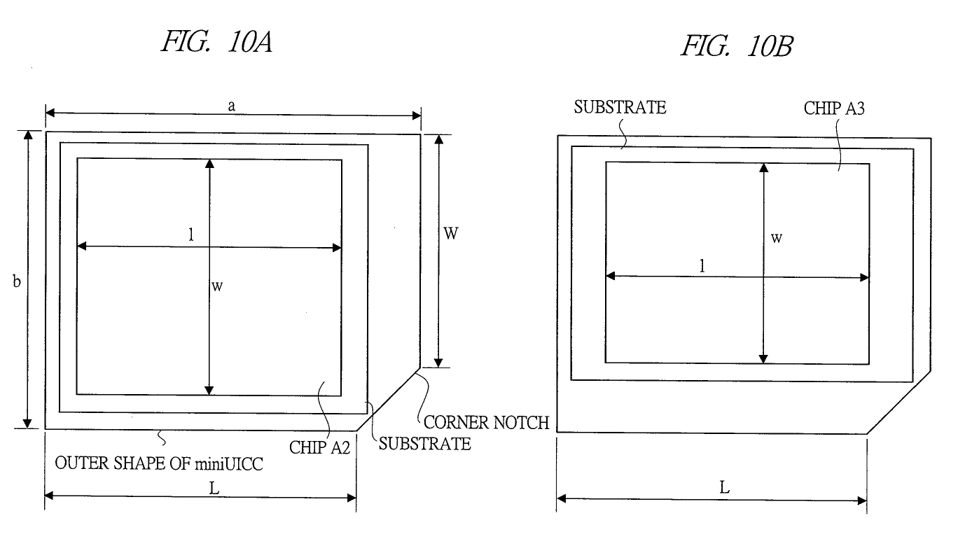

At this time, by reducing R2 to the minimum necessary (for example, R is set at 0.05 mm), a chip having a length l longer than L in FIG. 10 can be disposed so as to be near R2. By this means, the chip width w can be maximized. Note that R2 is formed so as to reduce the scraping of a connector by a corner of the thin card and also to promote the smooth insertion by reducing the insertion jam when the thin card is inserted into the adaptor.

As described above, according to the fifth embodiment, of the two corners of the thin card, the curvature of one corner that is near the notch portion is made smaller than that of the other corner having no notch portion, thereby mitigating the restriction on the area of the thin card due to the corner notch.

### Sixth Embodiment

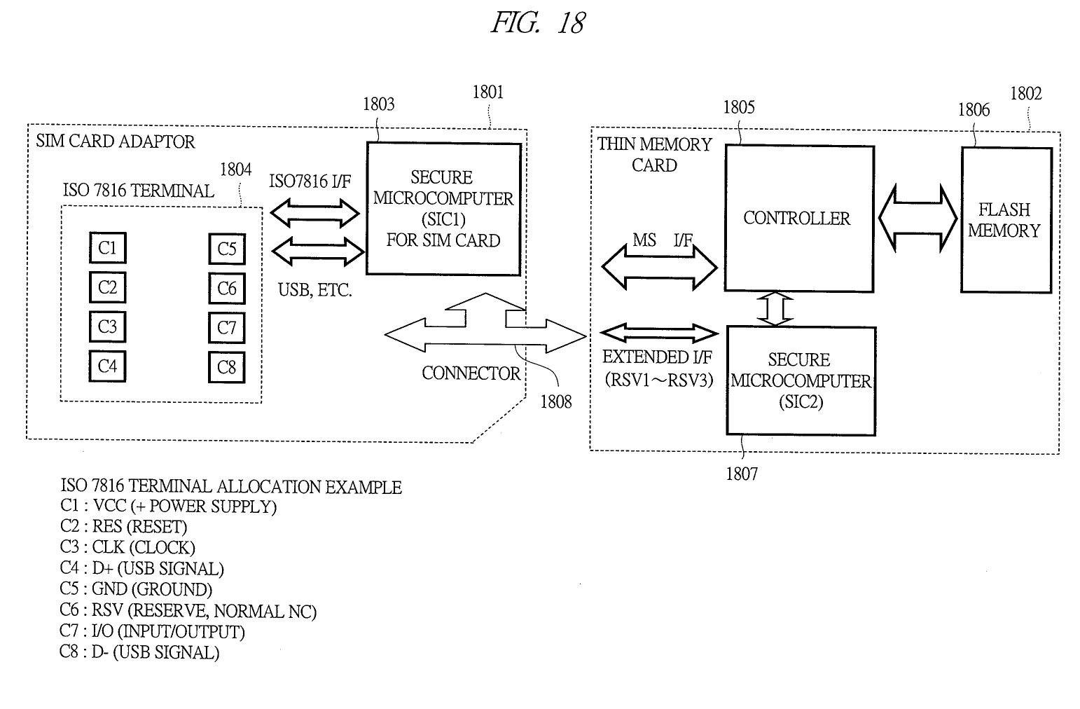

FIG. 18 is a block diagram showing the configuration of a SIM card according to the sixth embodiment of the present invention. By connecting a thin memory card (hereinafter also simply referred to as “card”) 1802 of the present invention to a SIM card adaptor (hereinafter also simply referred to as “adaptor”) 1801 via a connector 1808, a SIM card equipped with a flash memory 1806 can be formed. FIG. 18 also shows an example for describing a function of ISO 7816 terminals.

The SIM card adaptor 1801 includes, for example, a secure microcomputer (SIC1) 1803 for SIM card, ISO 7816 terminals 1804, and a connector 1808 for memory card. The thin memory card 1802 to be inserted into an adaptor has card terminals, and the card terminals are connected to connector terminals (not shown) of the connector 1808 provided in the adaptor, thereby exchanging the data, signals and others.

The thin memory card 1802 includes, for example, a controller 1805, a flash memory 1806 controlled by the controller, and a secure microcomputer (SIC2) 1807 provided according to need.

Here, the connector 1808 has an interface with the secure microcomputer 1803 and the mutual communication can be made therebetween.

Also, the connector 1808 may be partially or entirely connected to the ISO 7816 terminals 1804 according to need.

Furthermore, the connector 1808 may be connected to the controller 1805 inside the thin memory card via an interface for memory card, for example, a memory-stick (trademark: MEMORY STICK is a registered trade mark) interface (MS I/F), or may be connected to the secure microcomputer 1807 provided as required or a circuit achieving the function thereof (for example, the controller 1805 has a secure microcomputer function) via an extended I/F.

Also, the MS I/F may have a secure function.

Although the extended I/F has three lines RSV1 to RSV3 in the drawing, more number of lines may be provided.

The secure microcomputer (SIC1) 1803 for SIM card is connected to the ISO 7816 terminals 1804 via an ISO 7816 interface (I/F).

Also, reserved ISO 7816 terminals (for example, C4 and C8 in FIG. 18) may be used for USB. Furthermore, in another example, such reserved terminals may be used for SD-card I/F, MMC I/F, non-contact communication I/F and others.

The embodiment of this SIM card includes, for example, the case where SIC2 is used for secure communication between SIC1 of the adaptor and the thin card and for encryption processing, the case where SIC1 is omitted and SIC2 in the card is supposed to perform all processes, and the case where no SIC2 is provided inside the card. The SIM card adaptor 1801 has the connector 1808 for thin memory card 1802 and causes the thin memory card 1802 and the secure microcomputer 1803 in the SIM card adaptor 1801 to communicate with each other via the connector 1808. Also, a path for directly accessing to the ISO 7816 terminals 1804 can be provided as described above.

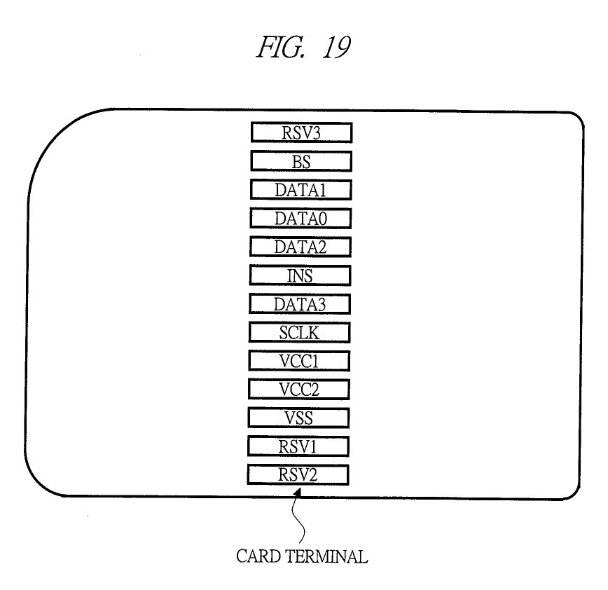

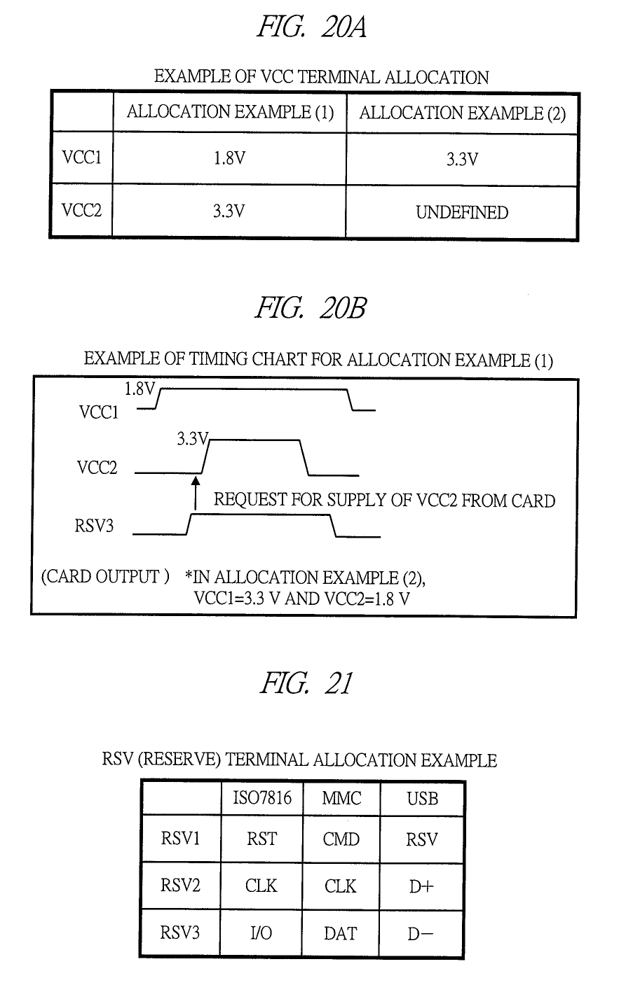

FIG. 19 is a drawing showing an example of terminal signals of the thin memory card 1802. FIG. 20 is a drawing showing an example of allocation of VCC terminals. FIG. 21 is a drawing showing an example of allocation of RSV (reserve) terminals.

FIG. 19 shows the case where the card terminals of the thin card are adapted to, for example, a memory stick micro (trademark: Memory Stick Micro is a registered trademark). The card terminals include INS which is a terminal for detecting whether the thin card has been inserted into the adaptor, BS which is a terminal indicative of a bus state, SCLK which is a terminal to which a serial clock for use in controlling data input/output of the card is input, DATA0-DATA3 which are terminals for data input/output, VCC1 which is a power supply voltage terminal, and VSS which is a ground voltage terminal.

Furthermore, in this example, four reserve terminals RSV1 to RSV3 and VCC2 which are extended terminals are provided.

The thin memory card 1802 shown here can support the power supplies and signal interfaces of 1.8 V and 3.3 V. The extended terminal VCC2 is used when an element operated only at 3.3 V is implemented as a part of the elements inside the card.

Note that, in the present application, 1.8 V means the voltage by which a normal operation can be ensured even when the voltage is increased or decreased from 1.8 V approximately by 10 percent.

Similarly, 3.3 V means the voltage by which an operation can be ensured even when the voltage is fluctuated from 3.3 V approximately by 10 percent.

An example of voltage allocation for VCC terminals when it is assumed that the flash memory operates at 3.3 V is shown in FIG. 20A. Here, when 1.8 V is applied to a power supply terminal VCC1, a power supply terminal VCC2 can be supplied with 3.3 V from outside.

Also, a reserve terminal may be used for the power supply control of power supplies for use in the thin card. An example of using a reserve terminal RSV3 is described here.

In an allocation example (1) in FIG. 20A, that is, when 1.8 V and 3.3 V are supplied, a control signal terminal which outputs signals for instructing the supply start and stop of 3.3 V to VCC2 at an appropriate timing after 1.8 V is supplied to VCC1 and the controller inside the card is activated is the reserve terminal RSV3. FIG. 20B shows a timing chart.

The reserve terminal RSV3 basically supplies an output from the thin card to the adaptor, but can perform bi-directional communications for obtaining a response from the adaptor.

Under a condition different from that in FIG. 20A, that is, in the case where 3.3 V is supplied to VCC1 and a flash memory operating only at 1.8 V is used for the thin card, when 3.3 V is supplied to VCC1, the controller inside the card can request the adaptor to supply 1.8 V to VCC2 in the same manner as described above.

An example of application of other reserve terminals is shown in FIG. 21. In the case of three terminals, functions as CMD (command), CLK (clock), and DAT (data) terminals of MMC and SD-I/F and additional ISO 7816 I/O, RES (reset), and CLK (clock) can be mounted. In the case of two terminals, a USB-mode I/F can be mounted. In order to avoid redundant use of RSV3 as a power supply control terminal, power supply control may be used only in an initial state at the power-on, and after the start of the normal use, the use of the terminal may be switched to a signal terminal for achieving another object.

Also, this mode switching may be made by using the data of a register provided inside the card in accordance with a command (instruction) at a memory card interface or an extended terminal interface.

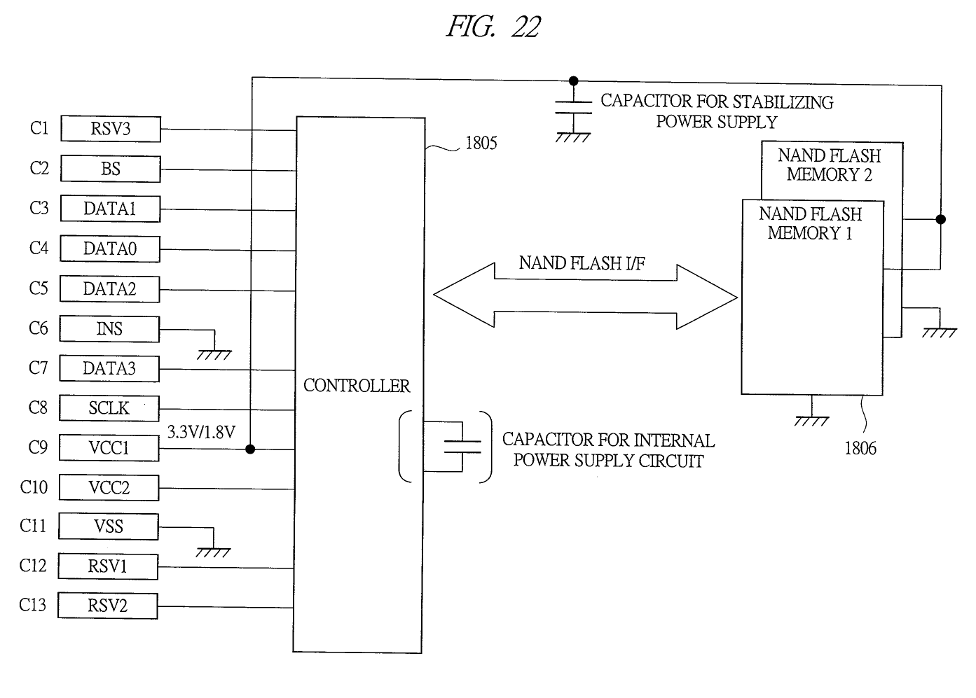

FIG. 22 is a block diagram showing a configuration relating to the power supply of the thin memory card 1802 in the first example (an example of a memory-stick interface).

FIG. 22 shows an example of the connection when the controller and the flash memory support both the power supplies of 3.3 V and 1.8 V. In this case, the operation is possible only with the supply of power of VCC1. A capacitor for internal power supply circuit and a capacitor for stabilizing power supply are optional. In the drawing, a NAND flash memory is shown as an example of a memory. Alternatively, a NOR-type or AND-type flash memory, ROM, RAM, or a mixture thereof may be used.

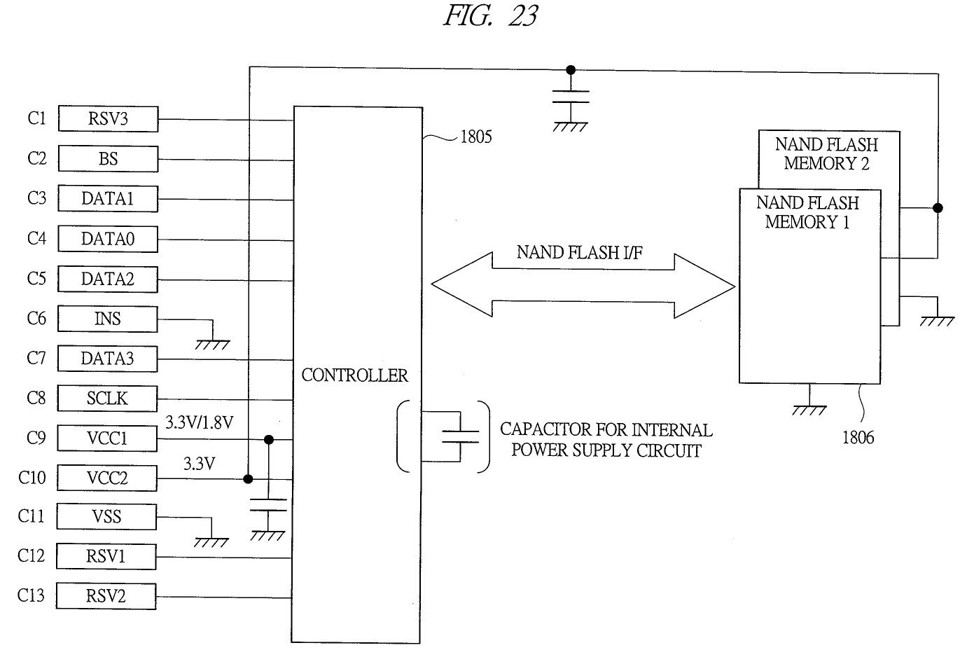

FIG. 23 is a block diagram showing a configuration relating to the power supply of the thin memory card 1802 in the second example (an example of a memory-stick interface).

FIG. 23 shows an example of the connection when the controller supports both the power supplies of 3.3 V and 1.8 V and the flash memory supports only the power supply of 3.3 V. After the controller starts up with the power supply of VCC1 via the RSV3 terminal, it requests a VCC2 supply timing at an appropriate timing. A capacitor for internal power supply circuit and a capacitor for stabilizing power supply are optional.

When the controller requests VCC2 but appropriate VCC2 is not supplied, the controller may terminate the card operation.

This can be achieved by the controller monitoring the voltage of VCC2.

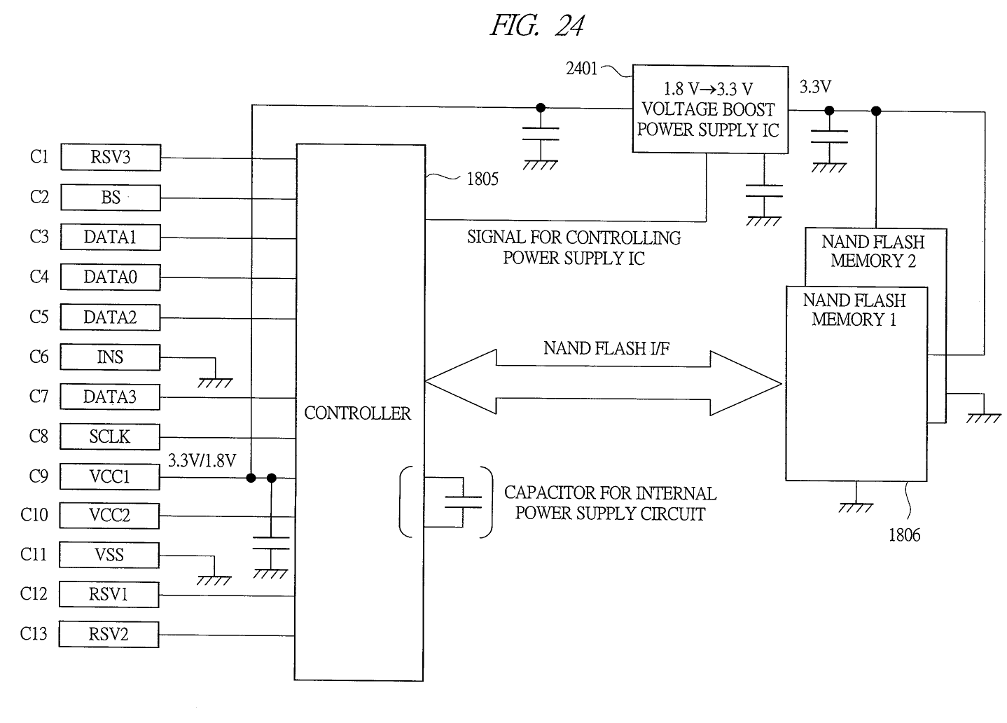

FIG. 24 is a block diagram showing a configuration relating to the power supply of the thin memory card 1802 in the third example (an example of a memory-stick interface).

FIG. 24 shows an example of the connection when the controller supports both the power supplies of 3.3 V and 1.8 V and the flash memory supports only the power supply of 3.3 V. A signal for controlling a power supply IC is input from the controller to a voltage boost power supply IC (1.8 V→3.3 V). Note that VCC2 and the controller may be connected to each other. A capacitor for internal power supply circuit is optional. When 1.8 V is supplied to VCC1, the controller 1805 outputs a signal for instructing the voltage boost power supply IC 2401 incorporated in the thin card to generate 3.3 V.

Then, 3.3 V is supplied to the NAND flash memory.

Although not shown in FIG. 24, the controller may monitor an output voltage and an input voltage of the voltage boost power supply IC to stably operate the thin card. Further, by providing a monitoring function, the card operation may be terminated when an abnormality occurs.

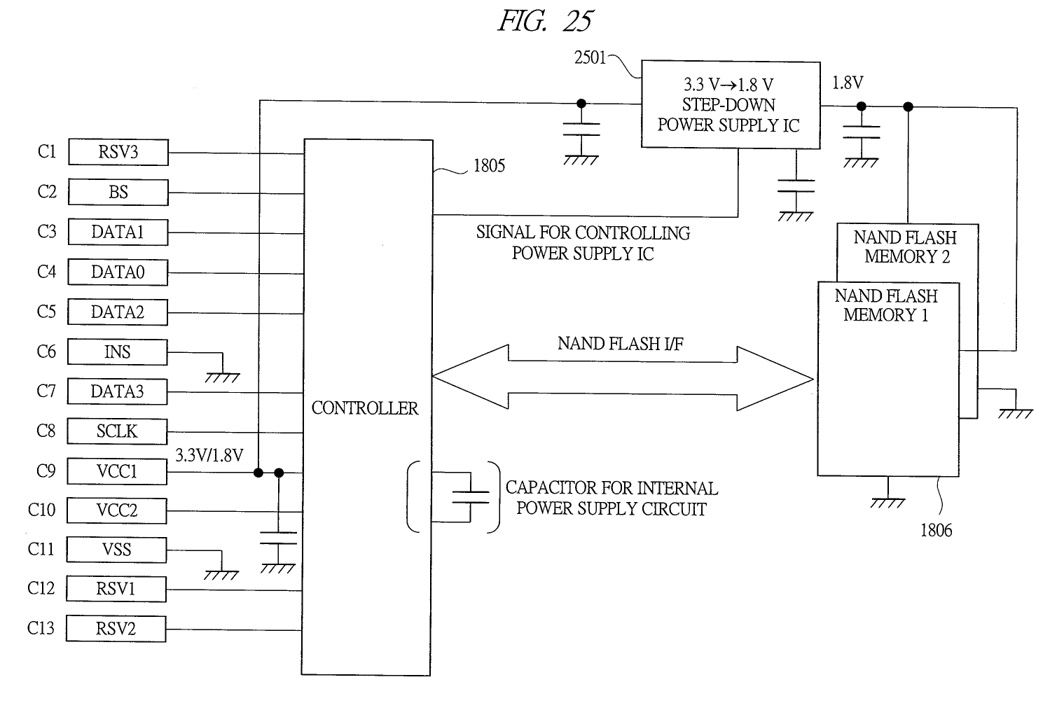

FIG. 25 is a block diagram showing a configuration relating to the power supply of the thin memory card 1802 in the fourth example (an example of a memory-stick interface).

FIG. 25 shows an example of the connection when the controller supports both the power supplies of 3.3 V and 1.8 V and the flash memory supports only the power supply of 1.8 V. When 3.3 V is supplied as an external voltage, a signal for controlling a step-down power supply IC 2501 is input from the controller to the step-down power supply IC (3.3 V→1.8 V). A capacitor for internal power supply circuit is optional.

Similar to the case shown in FIG. 24, the controller can monitor the voltage of the step-down power supply IC to make a determination for transition to an appropriate card operation or mode. When the overall current capacity from the external power supply is rather insufficient, the controller may decrease the operation speed of the card for the purpose of leveling the current consumption of voltage monitor and the step-down power supply IC, thereby suppressing an average current consumption.

### Seventh Embodiment

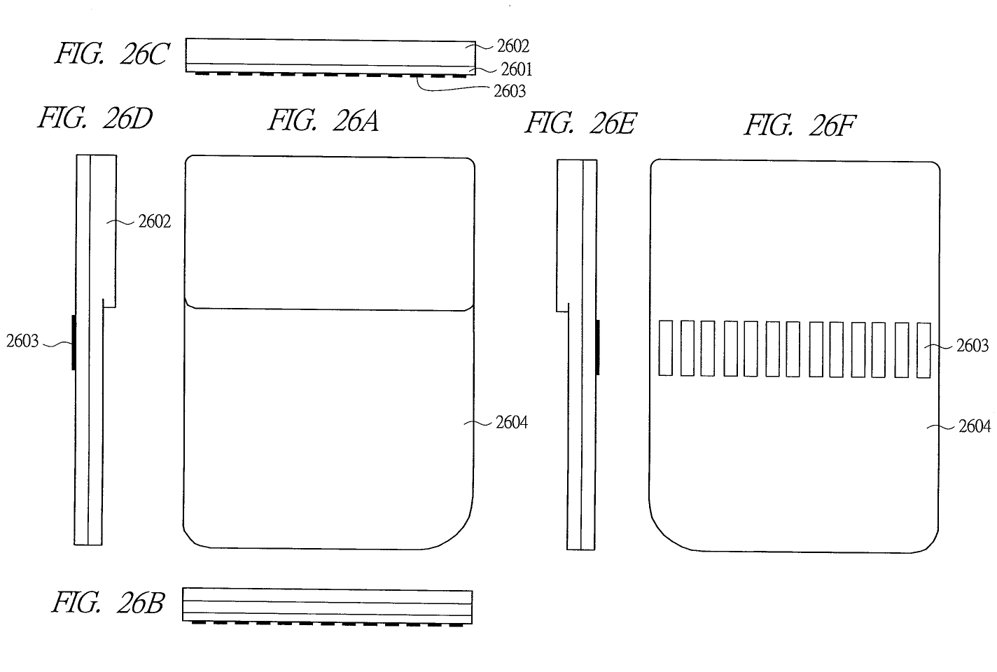

FIG. 26 is a drawing showing the outer shape of the thin memory card 1802 according to the seventh embodiment of the present invention, in which FIG. 26A is a plan view, FIG. 26B is a front view, FIG. 26C is a rear view, FIG. 26D is a left side view, FIG. 26E is a right side view, and FIG. 26F is a bottom view. FIG. 26 shows an example of a memory stick micro interface.

As shown in FIG. 26, an upper side of a substrate 2601 is covered with a mold 2602, and a plurality of connector terminals 2603 are formed on an exposed surface on a bottom side of the substrate 2601. A portion of the mold 2602 on the front side of the thin memory card 1802 has a two-step structure with different thicknesses. Also, in a thick portion, more IC chips can be stacked than a thin portion. Further, connector terminals 2603 on the bottom side of the thin memory card 1802 are arranged at the center of the card or away from the tip and rear end of the card. Furthermore, a corner 2604 on a side to be inserted into the adaptor is chamfered with a large radius of curvature R so as to fit with a notch position of the adaptor. If there is no notch restriction, a minimum radius of curvature R (for example, 0.05 mm or larger) or a minimum amount of chamfer that allows smooth card insertion will suffice.

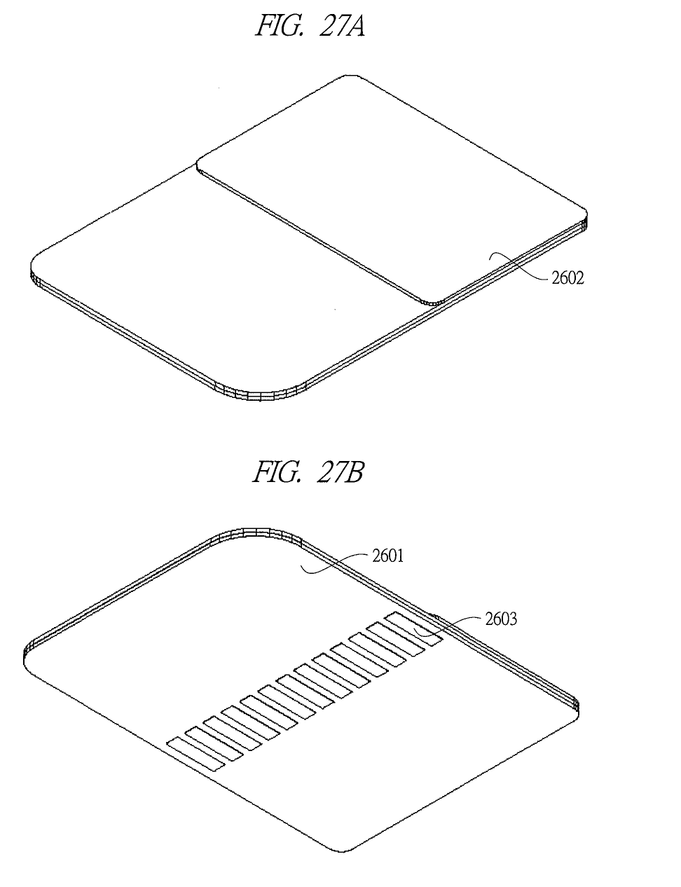

FIG. 27 is a perspective view showing the outer shape of the thin memory card 1802 according to an embodiment of the present invention, in which FIG. 27A is a drawing viewed obliquely from the top, and FIG. 27B is a drawing viewed obliquely from the bottom.

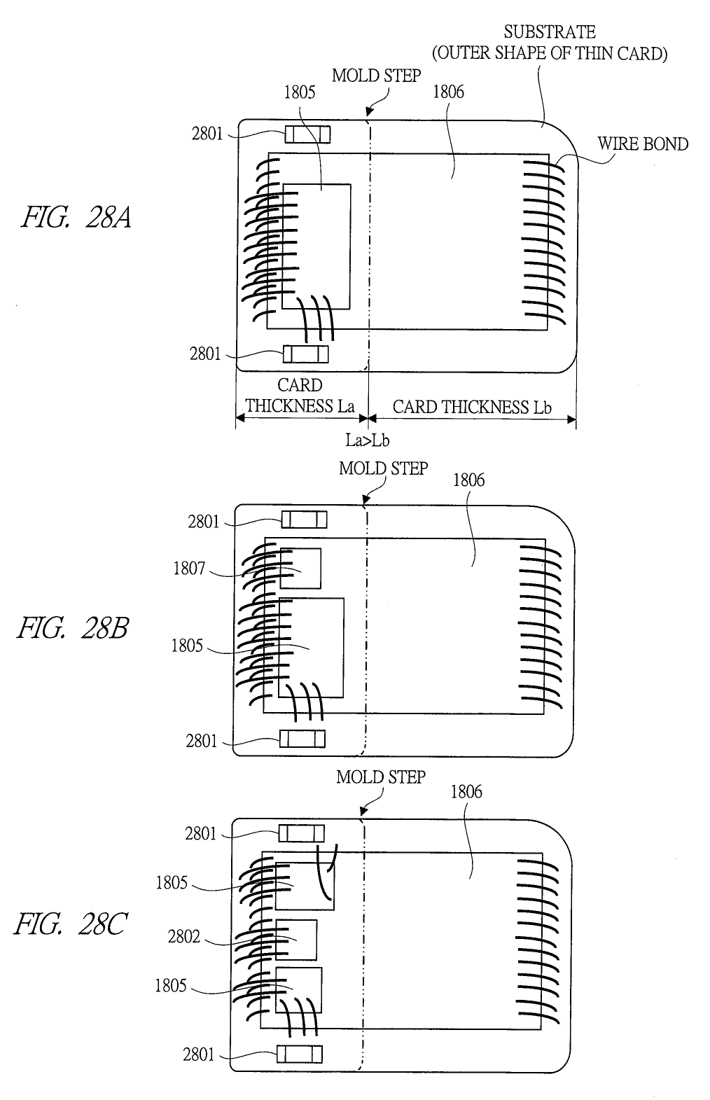

FIG. 28 is a drawing showing a mounting arrangement of chips in the thin memory card 1802 according to an embodiment of the present invention, in which FIG. 28A shows a basic example in the case of stacking chips, FIG. 28B shows an applied example 1, and FIG. 28C shows an applied example 2.

Note that the outer shape of the thin card and the substrate on which the chips are mounted are approximately identical in size to each other (the substrate is a little smaller in some cases), and it is assumed in FIG. 28 that the substrate and the outer shape of the card are identical in size to each other.

As shown in FIGS. 28A to 28C, when the flash memory is the largest among the chips to be mounted in the card and a total area of the arranged chips exceeds the area of the substrate if the flash memory and other chips are placed together on the substrate, the flash memory 1806 is mounted on the substrate and the controller 1805 for controlling the flash memory is stacked on an upper-left side of the flash memory (thick-mold portion). When the total area of the arranged chips is smaller than the area of the substrate if the flash memory and other chips are placed together on the substrate, the flash memory and the controller may be arranged together on the substrate.

Also, a chip component 2801 including a chip capacitor for use in stabilizing power supply, a chip resistor for use in, for example, impedance matching of the card terminals, a chip inductor for use in, for example, a DC/DC converter, and a transistor for use in, for example, power supply control is mounted on a left side of the substrate in the card. With a mold-step portion being taken as a boundary, a card thickness La on the left side is larger than a card thickness Lb on the right side.

As shown in FIG. 28B, in the applied example 1, a DC/DC converter 2802, which is a power supply IC that increases or decreases the external power supply voltage, the chip component 2801, and others may be mounted on the thick left side of the card in addition to the controller 1805.

Further, as shown in FIG. 28C, in the applied example 2, a secure microcomputer 1807 may be mounted on the thick left side of the card in addition to the controller 1805 and the DC/DC converter 2802. The power supply IC 2802, the secure microcomputer 1807, and the chip component 2801 in FIG. 28 are optional, and whether they are mounted is determined according to the performance required for the card. Also, while the chips and wirings provided on the substrate are connected through wire bonding in the drawings, a chip immediately above the substrate (the flash memory in this case) can be connected by the face-down flip-chip bonding.

Furthermore, a wiring substrate having wirings thereon can be stacked on the flash memory other than the chips, and the wiring substrate can be used as an interposer (intermediate wiring substrate).

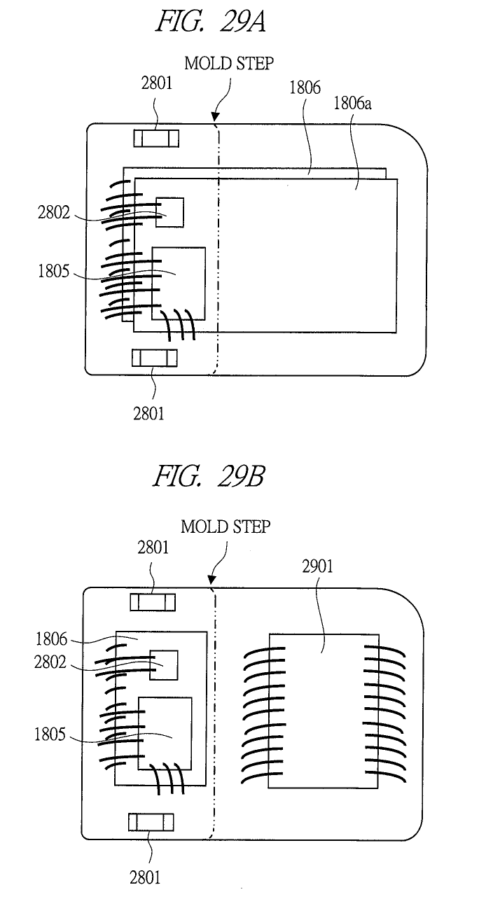

FIG. 29 is a drawing showing the chip mounting in the thin memory card 1802 according to the seventh embodiment of the present invention, in which FIG. 29A shows an applied example 3, and FIG. 29B shows an applied example 4.

As shown in FIG. 29A, in the applied example 3, two flash memories 1806 and 1806a are stacked, and then the controller 1805 and the DC/DC converter 2802 are stacked on a thick left side of the card. In this manner, the structure stacked in three stages may be possible.

Alternatively, as shown in FIG. 29B, in the applied example 4, at least one memory 2901 such as a flash memory, SRAM, or DRAM is mounted in addition to the flash memory 1806, and then the controller 1805 and the DC/DC converter 2802 may be stacked on a thick left side of the card.

### Eighth Embodiment

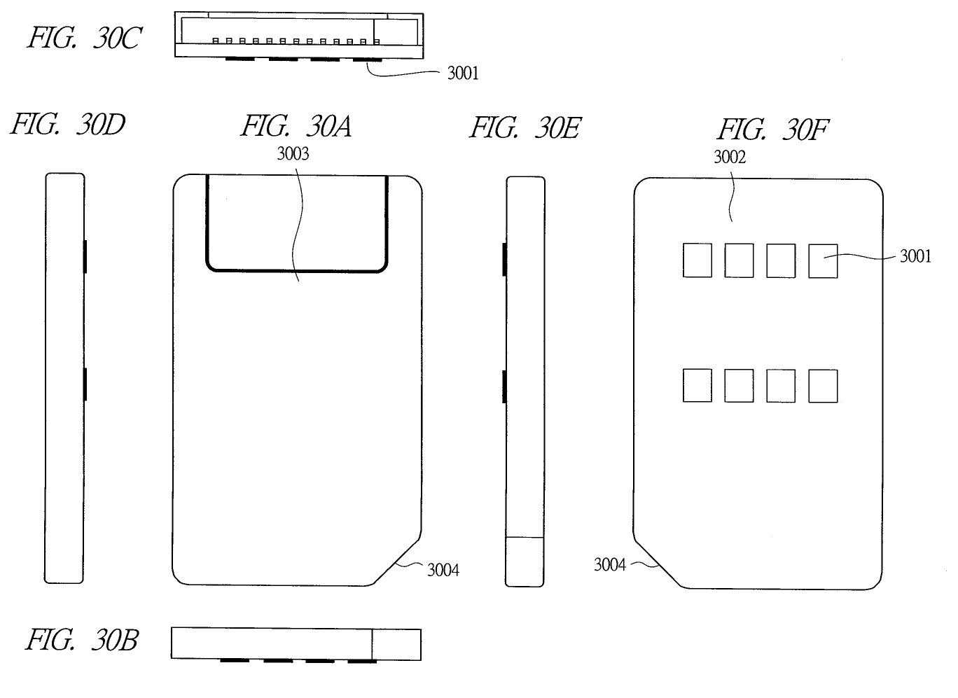

FIG. 30 is a drawing showing the outer shape of a Plug-in SIM conversion adaptor (SIM card adaptor 1801) according to the eighth embodiment of the present invention, in which FIG. 30A is a plan view, FIG. 30B is a front view, FIG. 30C is a rear view, FIG. 30D is a left side view, FIG. 30E is a right side view, and FIG. 30F is a bottom view.

As shown in FIG. 30, a plurality of connector terminals 3001 (corresponding to ISO 7816 terminals 1804 in FIG. 18) are formed on a substrate 3002 on a bottom side of the adaptor. Also, on an upper portion of an opening into which the thin memory card 1802 is inserted, an upper retainer plate (guide portion) 3003 having a retainer structure immediately above the contact terminals in FIG. 16 described in the fourth embodiment is formed. Furthermore, a notch 3004 for indicating a direction of the adaptor is provided at a corner.

FIG. 31 is a perspective view showing the outer shape of the Plug-in SIM conversion adaptor (SIM card adaptor 1801) according to the eighth embodiment of the present invention, in which FIG. 31A is a drawing viewed from the top, and FIG. 31B is a drawing viewed from the bottom.

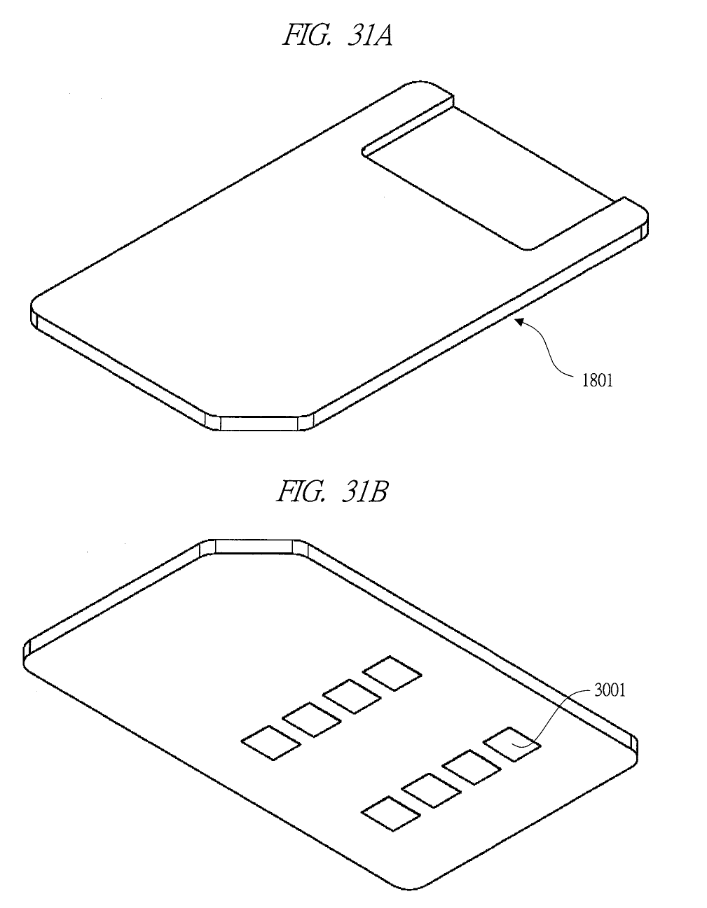

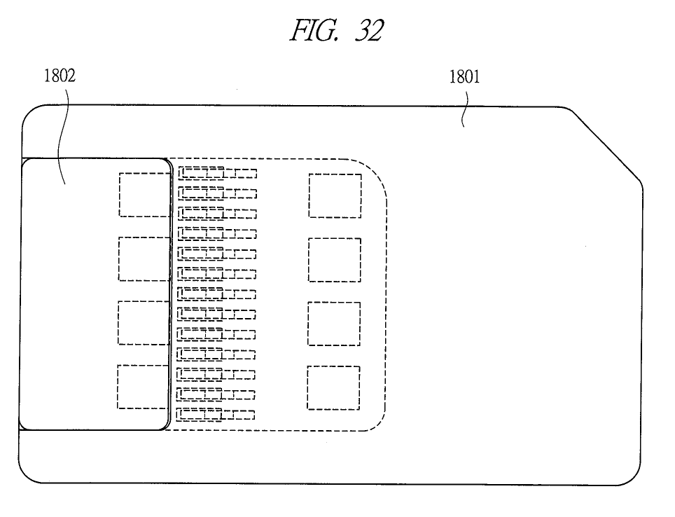

FIG. 32 is a plan view showing the outer shape after the thin memory card 1802 is inserted into the Plug-in SIM conversion adaptor (SIM card adaptor 1801).

As shown in FIG. 32, the thin memory card 1802 is inserted from the left side of the SIM card adaptor 1801, so that the card terminals and the connector terminals are in contact with each other. A retainer structure of the SIM card adaptor 1801 immediately above the contact terminals is provided above the connector terminals of the thin memory card 1802.

FIG. 33 is a longitudinal cross-sectional view showing the structure before and after the thin memory card 1802 is inserted into the Plug-in SIM conversion adaptor, in which FIG. 33A shows the state before the thin memory card 1802 is inserted, and FIG. 33B shows the state after the thin memory card 1802 is inserted.

As shown in FIG. 33A, an IC chip 3301 having functions of a SIC (secure microcomputer) and a memory card interface and a chip component 3302 such as a passive element or an active element are mounted on the substrate 3002 in the Plug-in SIM conversion adaptor.

Also, on the substrate 3002, connector terminals 3303 are adhered by, for example, soldering or welding at a portion where they are in contact with the connector terminals of the thin memory card 1802. The adhered portion of the connector terminals 3303 is provided on a side of a card insertion port, thereby preventing the destruction of the connector terminals when the card is inserted.

Also, the upper retainer plate 3003 is provided to an upper portion of the connector terminals 3303, thereby preventing the deflection of the card. On a bottom side of the substrate 3302, the connector terminals 3001, which are ISO 7816 electrodes, are formed.

As shown in FIG. 33B, the thin memory card 1802 is inserted into the Plug-in SIM conversion adaptor, so that the connector terminals 3303 and the card terminals are in contact with each other.

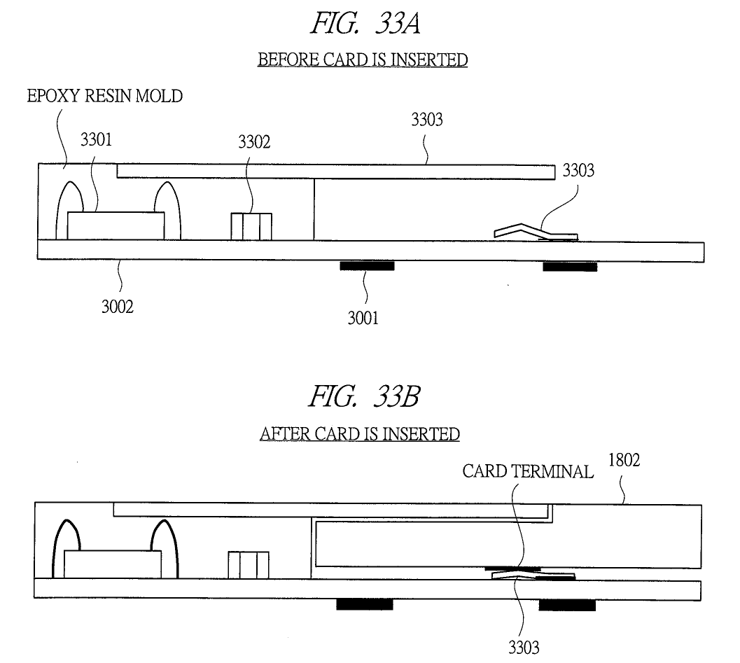

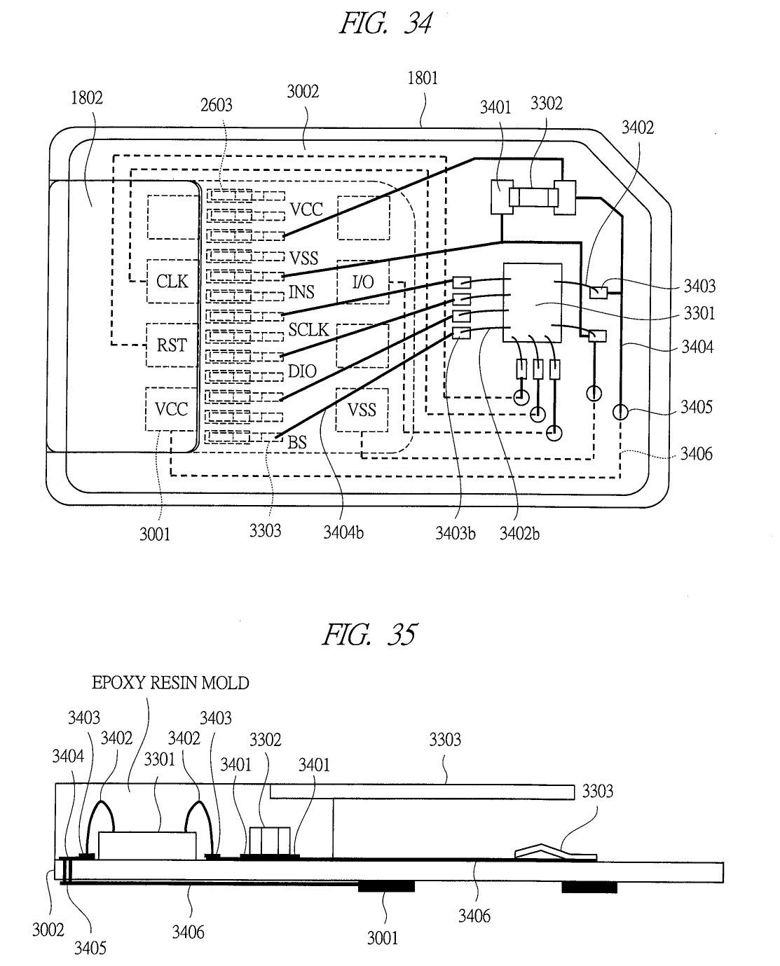

FIG. 34 is a plan view showing a wiring structure when the thin memory card is inserted into the Plug-in SIM conversion adaptor.

As shown in FIG. 34, the thin memory card 1802 is inserted into the SIM card adaptor 1801, and the card terminals 2603 of the card and the connecter terminals 3303 of the adaptor are connected to each other. On the substrate 3002 of the SIM card adaptor 1801, the chip component 3302 is connected via an electrical connection pad 3401 made of, for example, solder or silver paste (the drawing shows the case of solder mounting). Furthermore, on the substrate 3002, the IC chip 3301 having the SIC and memory card interface functions is connected to a bonding pad 3403 on the substrate through a wire bonding 3402. Then, the bonding pad 3403 is connected to a front-surface wiring 3404 provided on the front surface of the substrate. The front-surface wiring 3404 is connected to a bottom-surface wiring 3406 provided on the bottom surface of the substrate via VIA wiring 3405.

The bottom-surface wiring 3406 is connected to the connector terminals 3001 provided on the bottom surface of the substrate.

Also, the IC chip 3301 is connected to the connecter terminals 3303 on the front surface of the substrate via a bonding wire 3402b, a bonding pad 3403b, and a front-surface wiring 3404b.

The connector terminals 3303 are connected to the card terminals 2603, so that the card terminals 2603 and the IC chip 3301 are connected to each other.

One wiring path has been described as an example here, but as is evident from FIG. 34, a plurality of wirings are provided.

FIG. 35 is a cross-sectional view showing a wiring structure of the Plug-in SIM conversion adaptor.

Here, the IC chip 3301 and the wire bonding 3402 are molded with epoxy resin for sealing or others. The retainer plate 3003 and this mold resin may be integrally formed by adhesion or the like in the adaptor at an appropriate position in the structure.

### Ninth Embodiment

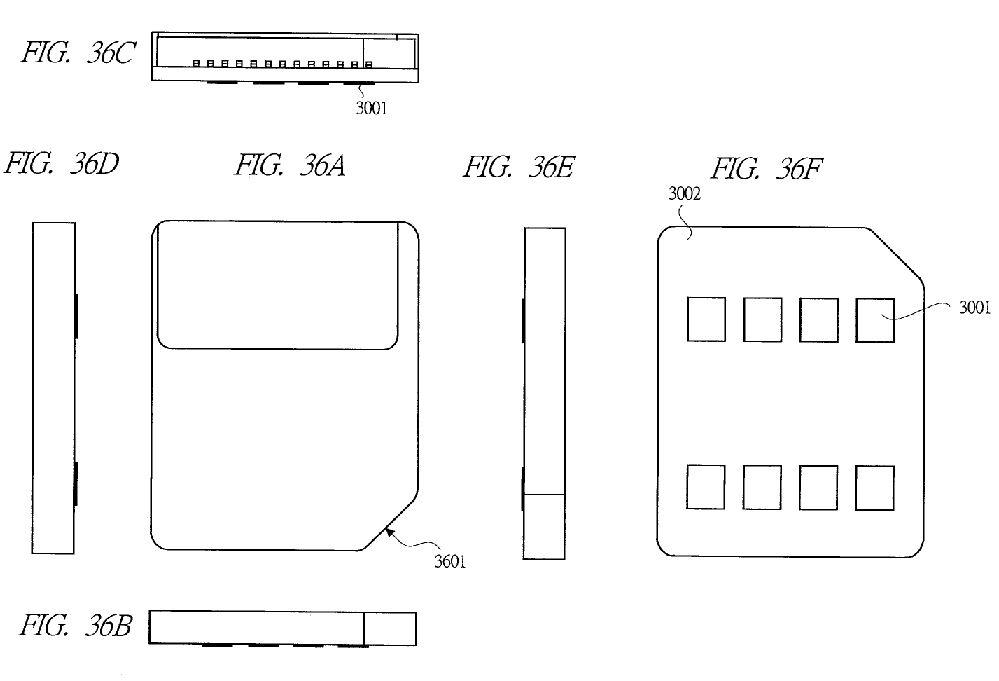

FIG. 36 is a drawing showing the outer shape of a miniUICC adaptor (corresponding to the SIM card adaptor 1801) 3601 according to the ninth embodiment of the present invention, in which FIG. 36A is a plan view, FIG. 36B is a front view, FIG. 36C is a rear view, FIG. 36D is a left side view, FIG. 36E is a right side view, and FIG. 36F is a bottom view.

The miniUICC adaptor 3601 shown in FIG. 36 corresponds to the Plug-in SIM conversion adaptor and has a similar structure, and the thin memory card 1802 is inserted thereinto.

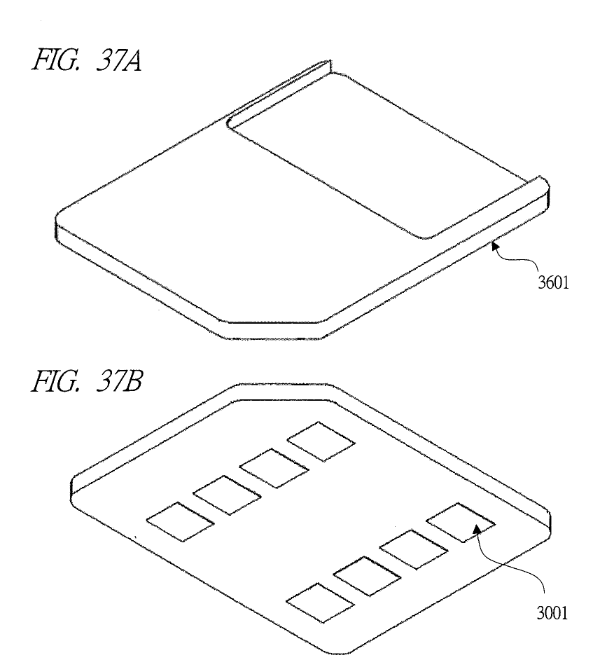

FIG. 37 is a perspective view showing the outer shape of the miniUICC adaptor 3601 (corresponding to the SIM card adaptor 1801), in which FIG. 37A is a drawing viewed from the top, and FIG. 37B is a drawing viewed from the bottom. Also, the miniUICC adaptor of FIG. 36 corresponding to the Plug-in SIM adaptor of FIG. 30 has similar electrical circuitry. However, since the card area of the miniUICC is small, the IC chip 3301 and other components 3302 are desirably embedded in the wiring substrate so as to reduce the mounting area and thickness. The reduction in the mounting area and thickness can be achieved by polishing the IC chip to have smaller thickness and employing a connection technique of gold bumps and solder bumps. Although not shown here, a connector connection structure with the thin card 1802 is similar to that of the connector contact terminals in FIG. 35.

### Tenth Embodiment

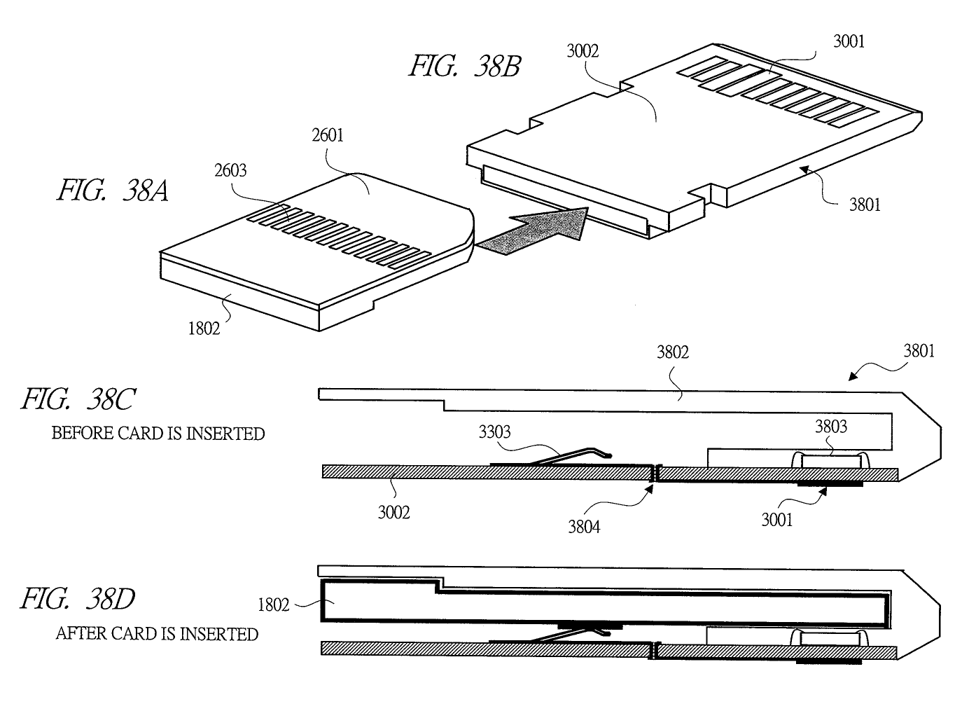

FIG. 38 is a drawing showing an adaptor of Memory Stick Micro (M2: trademark) as an outer-shape conversion adaptor for thin memory card and an internal connection of the M2 adaptor according to the tenth embodiment of the present invention, in which FIG. 38A is a drawing showing the thin memory card 1802, FIG. 38B is a drawing showing a conversion adaptor 3801, FIG. 38C is a cross-sectional view showing the conversion adaptor 3801 before the card insertion, and FIG. 38D is a cross-sectional view showing the conversion adaptor 3801 after the card insertion.

As shown in FIG. 38, a power supply IC 3803 is mounted in the conversion adaptor 3801. The power supply IC whose operation has been described with reference to FIGS. 24 and 25 supplies power to the thin memory card 1802 so as to support both the power supplies of 1.8 V and 3.3 V of the M2 card. Here, the thin card 1802 is mounted with a flash memory operating at a 3.3 V power supply (power supply of 3.3 V and about 3.3 V) and a controller operating at both 1.8 V and 3.3 V. 3.3 V is supplied via VCC2 to the thin memory card 1802 in accordance with a control signal from the controller in the thin card. With the control signal, a timing request is received via RSV3 from the thin memory card 1802. In the case of a flash memory operating only at (and about) 1.8 V, this method can be achieved by supplying 1.8 V to VCC2 in accordance with a control signal from the controller when 3.3 V is supplied to VCC1.

As described above, the power supply IC for the M2 adaptor may be a multi-power supply that generates two types of voltage for supplying the voltages of 1.8 V and 3.3 V respectively to the power supply voltages of 3.3 V and 1.8 V to be used. In the substrate 3002, front-surface wirings and bottom-surface wirings are connected via a through hole 3804. The thin memory card 1802 is inserted into an adaptor housing 3802, so that the connector terminals 3303 are connected to achieve the interconnection to the power supply IC and signal terminals and power supply terminals of M2 via the wirings on the substrate and the through hole. The power supply IC 3803 is connected through wire bonding in the drawing and is sealed with epoxy resin though not shown.

A retainer plate 3802 is integrally molded with or adhered to a resin-molded region to form an outer shape.

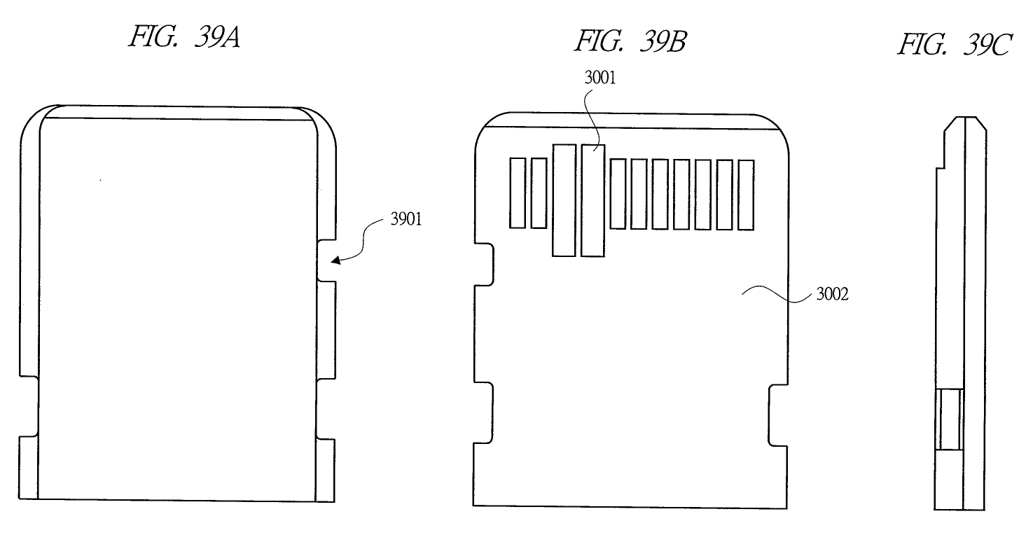

FIG. 39 is a drawing showing an outer shape of the outer-shape conversion adaptor 1 for thin memory card (M2 adaptor), in which FIG. 39A is a plan view, FIG. 39B is a bottom view, and FIG. 39C is a side view.

As shown in FIG. 39A, a notch 3901 is provided on a side surface of the conversion adaptor. This notch can be used to prevent an inadvertent dislocation of the card and used as an operational region of a card insertion detection switch on a host device.

### Eleventh Embodiment

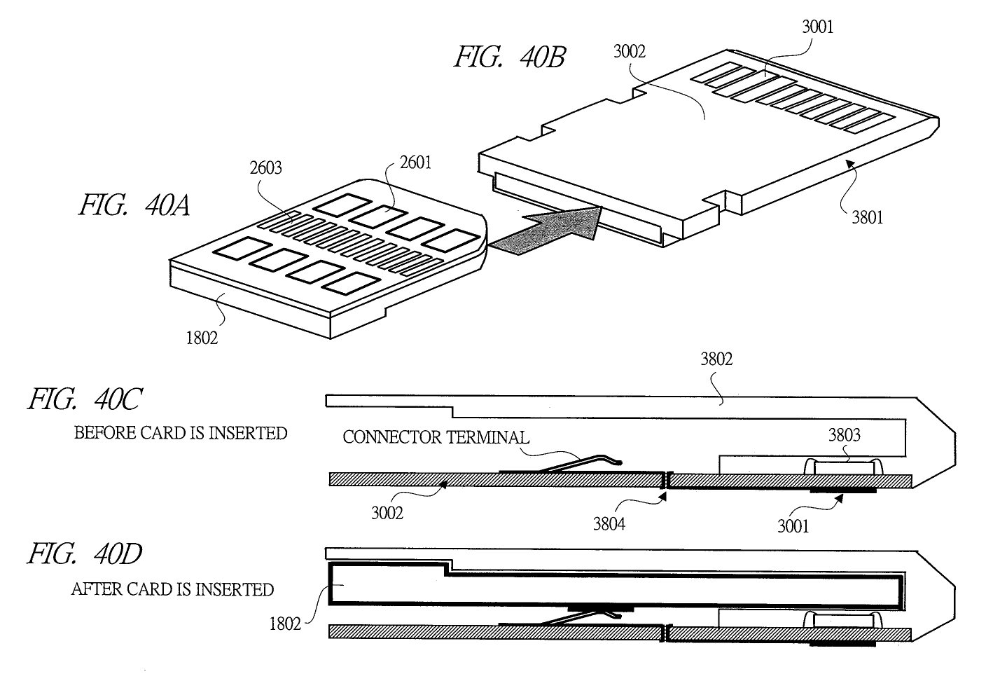

FIG. 40 is a drawing showing an adaptor of another Memory Stick Micro (M2) as an outer-shape conversion adaptor for thin memory card and an internal connection of the M2 adaptor according to the eleventh embodiment of the present invention, in which FIG. 40A is a drawing showing the thin memory card 1802, FIG. 40B is a drawing showing the conversion adaptor 3801, FIG. 40C is a cross-sectional view showing the conversion adaptor 3801 before the card insertion, and FIG. 40D is a cross-sectional view showing the conversion adaptor 3801 after the card insertion.

As shown in FIG. 40, the power supply IC 3803 is mounted in the conversion adaptor 3801. The power supply IC supplies power to the thin memory card 1802 so as to support both the power supplies of 1.8 V and 3.3 V of the M2 card. Here, 3.3 V is supplied via VCC2 to the thin memory card 1802. With the control signal, a timing request is received via RSV3 from the thin memory card 1802. The same operation goes for 1.8 V described above.

In the substrate 3002, front-surface wirings and bottom-surface wirings are connected via the through hole 3804. The thin memory card 1802 is inserted into the adaptor housing 3802 and the connector terminals 3303 are connected in the same manner as described above.

Also, in the M2 adaptor, the power supply IC can be omitted in accordance with the power supply supporting capability of the thin card 1802 (also in FIGS. 24 and 25).

### Twelfth Embodiment

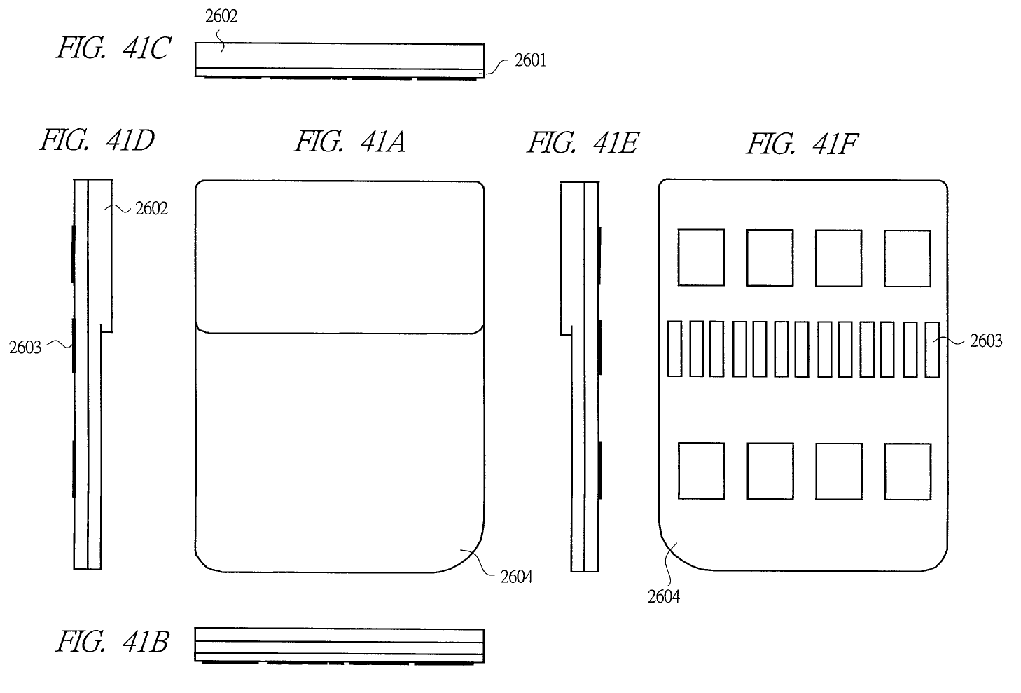

FIG. 41 is a drawing showing the outer shape of a SIM-function-equipped thin memory card according to the twelfth embodiment of the present invention, in which FIG. 41A is a plan view, FIG. 41B is a front view, FIG. 41C is a rear view, FIG. 41D is a left side view, FIG. 41E is a right side view, and FIG. 41F is a bottom view. FIG. 41 shows an example of a memory stick micro interface.

As shown in FIG. 41, an upper side of the substrate 2601 is covered with the mold 2602, and a plurality of connector terminals 2603 are formed on an exposed surface on a bottom side of the substrate 2601. The portion of the mold 2602 on the front side of the thin memory card 1802 has a two-step structure with different thicknesses. Also, in a thick portion, more IC chips can be stacked. Further, connector terminals 2603 on the bottom side of the thin memory card 1802 are arranged at the center. Furthermore, the corner 2604 on the side to be inserted into the adaptor is chamfered with a large radius of curvature R so as to fit with a notch position of the adaptor. If there is little notch restriction, a minimum radius of curvature R (both the R1 and R2 in FIG. 17) will suffice.

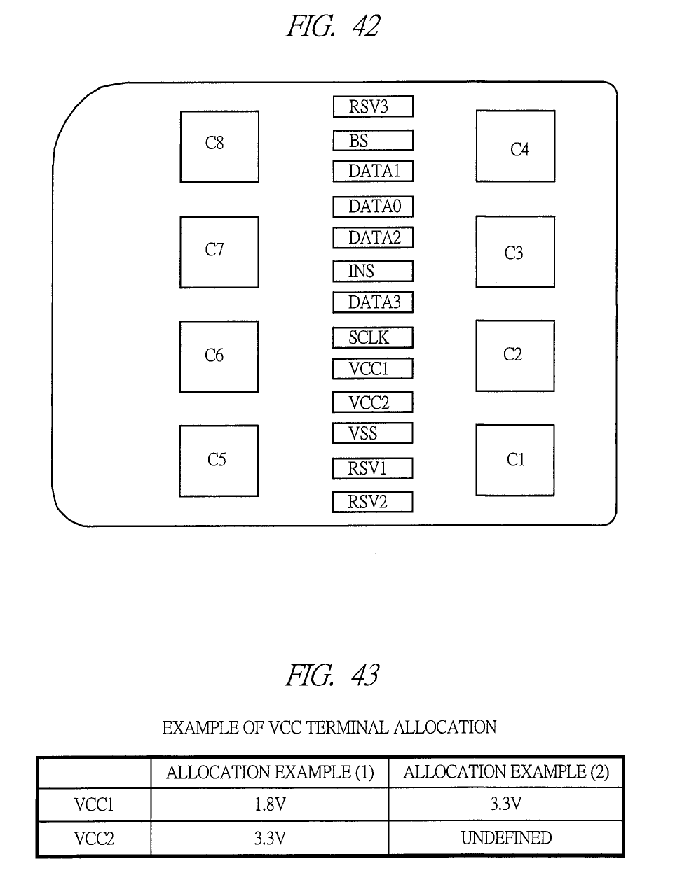

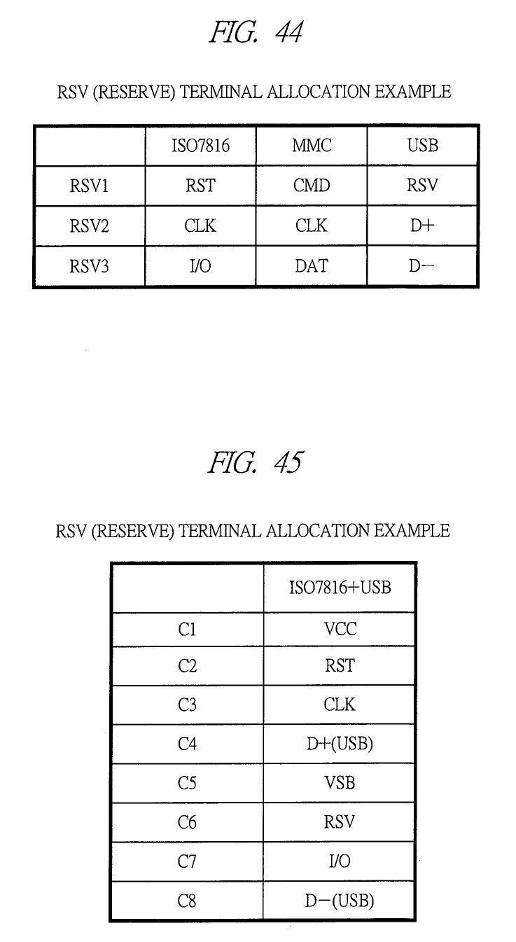

FIG. 42 is a drawing showing an example of card terminal arrangement of a thin memory card 2 electrically equipped with a SIM function and an ISO 7816 function (an example of MS I/F+ISO 7816 I/F). FIG. 43 is a drawing showing an example of allocation of VCC terminals. FIG. 44 is similar to FIG. 21 and shows an example of allocation of RSV (reserve) terminals as an extended function. FIG. 45 is a signal arrangement drawing of the terminals for electrically extending the ISO 7816 function newly provided this time.

As an example of allocation of a supply control terminal for VCC2, RSV3 is allocated. RSV3 is allocated as a control signal terminal which instructs the supply of 3.3 V to VCC2 at an appropriate timing after 1.8 V is supplied to VCC1 and the controller inside the card is activated. RSV3 basically supplies an output, but can perform bi-directional communication for obtaining a response from a host. As the method of supplying 1.8 V to a component operating only at 1.8 V inside the thin card when 3.3 V is supplied to VCC1 described above, RSV3 can be operated as a control terminal in the same manner.

Also, when power supply control is not necessary, control of RSV3 can be omitted. More specifically, power can be automatically supplied to VCC2 at an appropriate timing of power-on of VCC1. The operation is such that 3.3 V is supplied to VCC2 in the case of 1.8 V for VCC1 and 1.8 V is supplied to VCC2 in the case of 3.3 V for VCC1. Furthermore, both power supplies are not necessarily required depending on the purpose.

### Thirteenth Embodiment

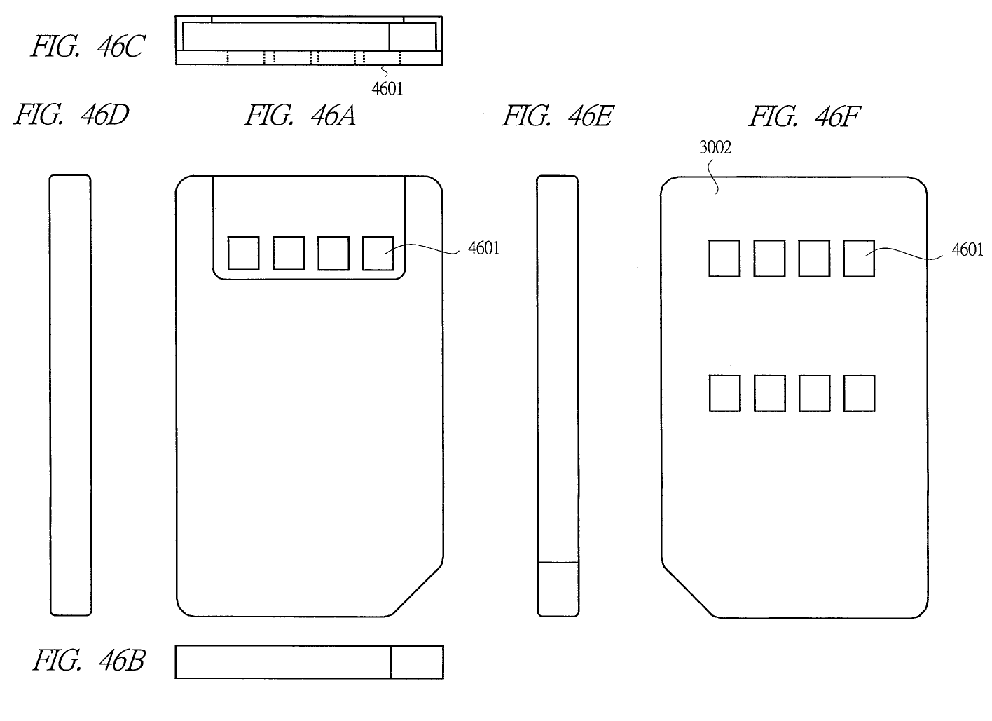

FIG. 46 is a drawing showing the outer shape of a Plug-in SIM conversion adaptor 2 (SIM card adaptor 1801) according to the thirteenth embodiment of the present invention, in which FIG. 46A is a plan view, FIG. 46B is a front view, FIG. 46C is a rear view, FIG. 46D is a left side view, FIG. 46E is a right side view, and FIG. 46F is a bottom view.

As shown in FIG. 46, a plurality of openings (penetrating windows) 4601 for plural connector terminals are formed on the substrate 3002 on a bottom side of the adaptor. Also, the extended terminals for ISO 7816 shown in FIG. 45 of the connector terminals 2603 of the thin memory card 1802 shown in FIG. 42 are exposed through the openings 4601.

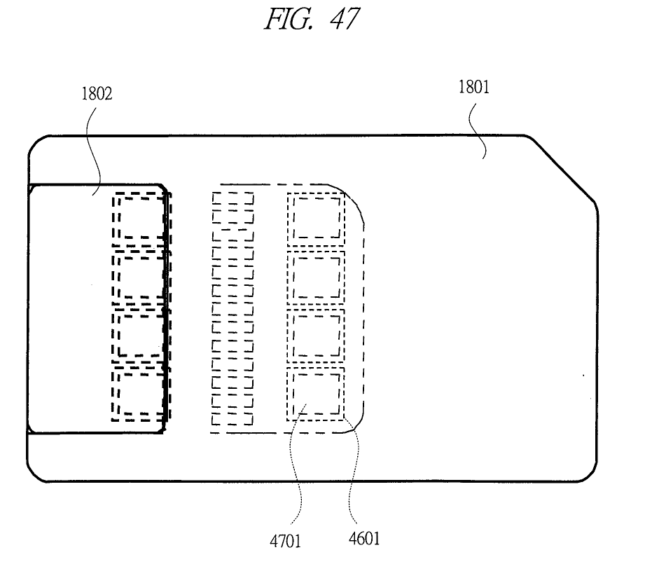

FIG. 47 is a plan view showing the outer shape after the thin memory card 1802 shown in FIG. 42 is inserted into the Plug-in SIM conversion adaptor (SIM card adaptor 1801).

As shown in FIG. 47, the thin memory card 1802 is inserted from a left side of the SIM card adaptor 1801, so that ISO 7816 terminals 4701 (corresponding to the connector terminals 2603) of the thin memory card 1802 are exposed through the openings (penetrating windows) 4601 for plural connector terminals. At this time, the memory-stick micro interface terminal and RSV1 to RSV3 shown in FIG. 42 are covered inside the adaptor and are not exposed to the outside. In this manner, unused terminals can be dielectrically isolated.

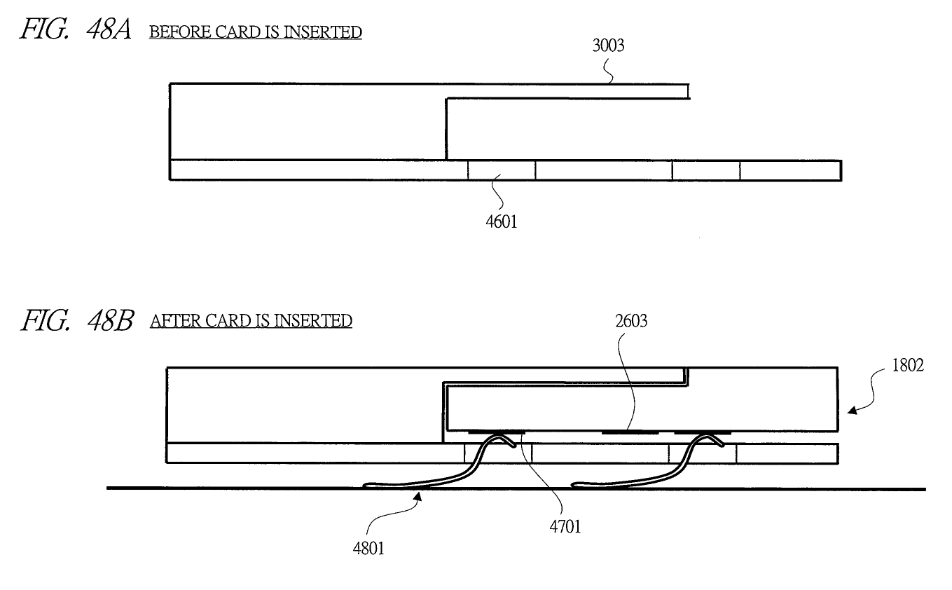

FIG. 48 is a longitudinal cross-sectional view showing the structure before and after the thin memory card 1802 is inserted into the Plug-in SIM conversion adaptor 2, in which FIG. 48A shows the state before the thin memory card 1802 is inserted, and FIG. 48B shows the state after the thin memory card 1802 is inserted. In particular, FIG. 48B also shows a state in which the Plug-in SIM adaptor mounted with the thin memory card is connected to the ISO 7816 connector terminals of a host device.

As shown in FIG. 48B, the connector terminals of a host-side socket 4801 and the ISO 7816 terminals 4701 of the SIM-function-equipped thin memory card 1802 are connected through the openings 4601. This is characterized in that, since the thickness of an insulating plate forming the opening of the adaptor is sufficiently thin and the opening is sufficiently large, the connector terminals of the host socket can pass through the opening to make a direct contact with the extended ISO 7816 terminals of the thin card. Accordingly, a thin SIM adaptor having a simple structure can be achieved at a very low cost.

### Fourteenth Embodiment

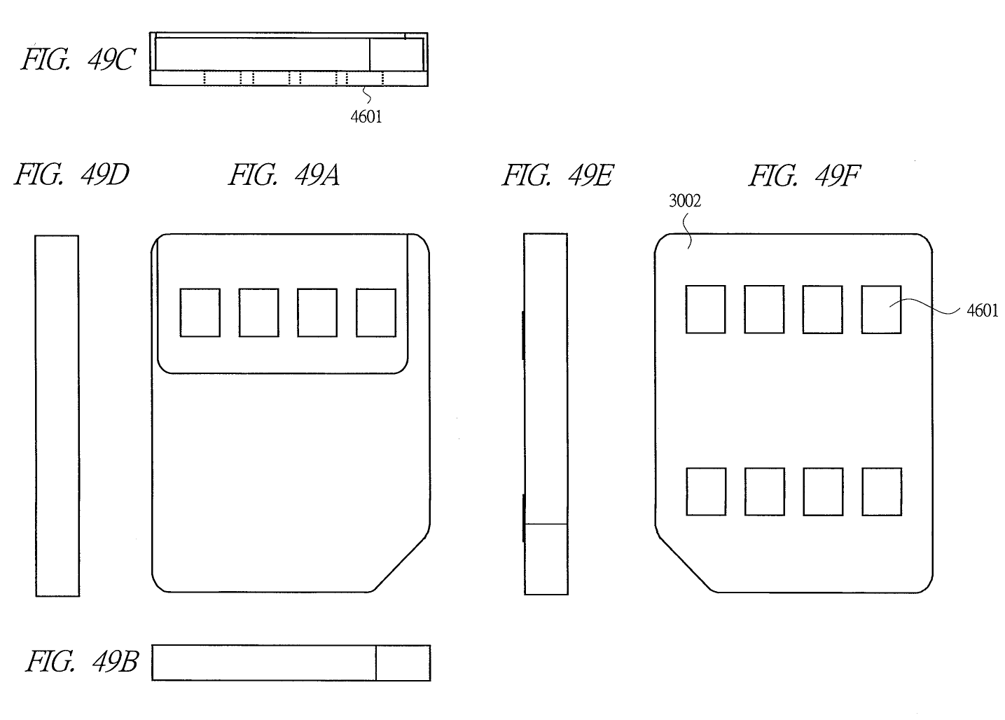

FIG. 49 is a drawing showing the outer shape of a miniUICC adaptor 2 (corresponding to the SIM card adaptor 1801) according to the fourteenth embodiment of the present invention, in which FIG. 49A is a plan view, FIG. 49B is a front view, FIG. 49C is a rear view, FIG. 49D is a left side view, FIG. 49E is a right side view, and FIG. 49F is a bottom view.

The miniUICC adaptor 2 shown in FIG. 49 corresponds to the Plug-in SIM conversion adaptor 2 described above and has a similar structure, and the thin memory card 1802 is inserted thereinto. Further, the connector terminals of the thin memory card 1802 are exposed through openings 4601. This is a function similar to that of the Plug-in SIM adaptor shown in FIG. 46.

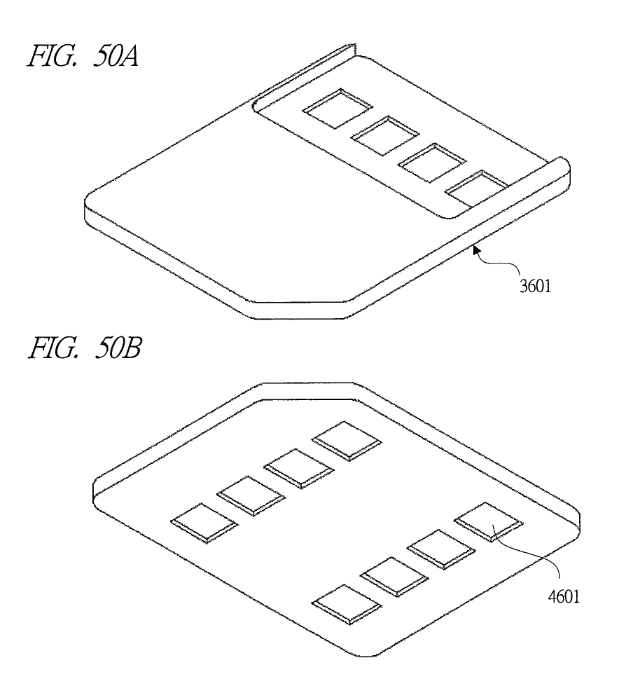

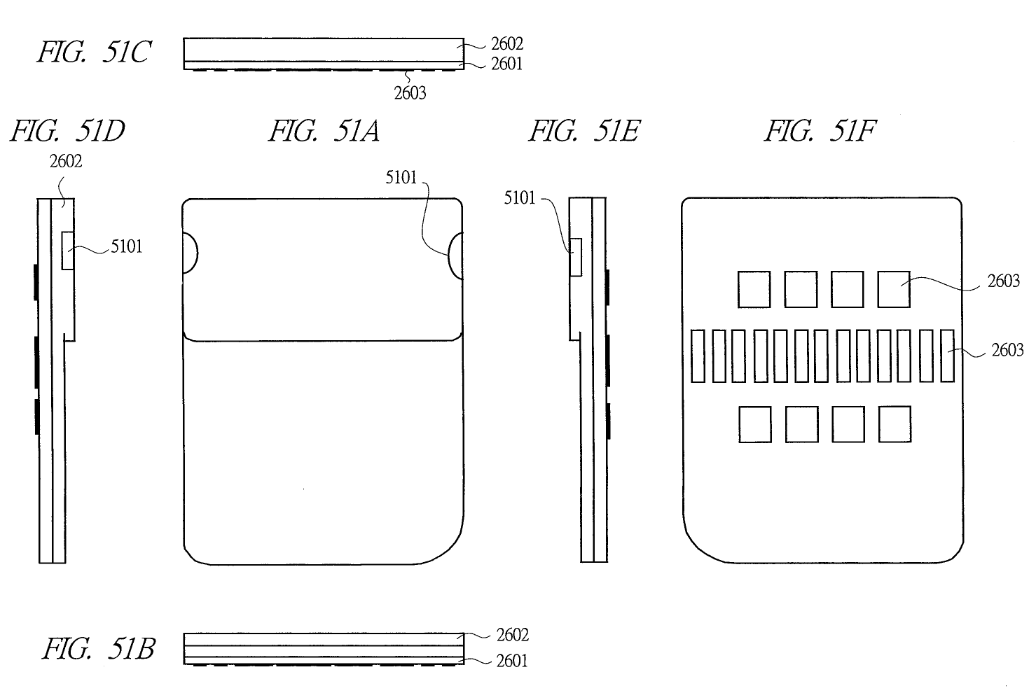

FIG. 50 is a perspective view showing the outer shape of the miniUICC adaptor 2, in which FIG. 50A is a drawing viewed from the top, and FIG. 50B is a drawing viewed from the bottom. FIG. 51 is a drawing showing the outer shape of a thin memory card 3 with notch according to the fourteenth embodiment of the present invention, in which FIG. 51A is a plan view, FIG. 51B is a front view, FIG. 51C is a rear view, FIG. 51D is a left side view, FIG. 51E is a right side view, and FIG. 51F is a bottom view.

As shown in FIG. 51, a notch 5101 is provided on a side surface of the mold 2602. This notch 5101 has a non-penetrating structure provided for the purpose of preventing the card dislocation and locking the card at a position. Since the notch does not penetrate, the area of the substrate 2601 can be utilized to maximum, and chips having a large width w (for example, flash memory chips) and not restricted by the notch can be mounted.

### Fifteenth Embodiment

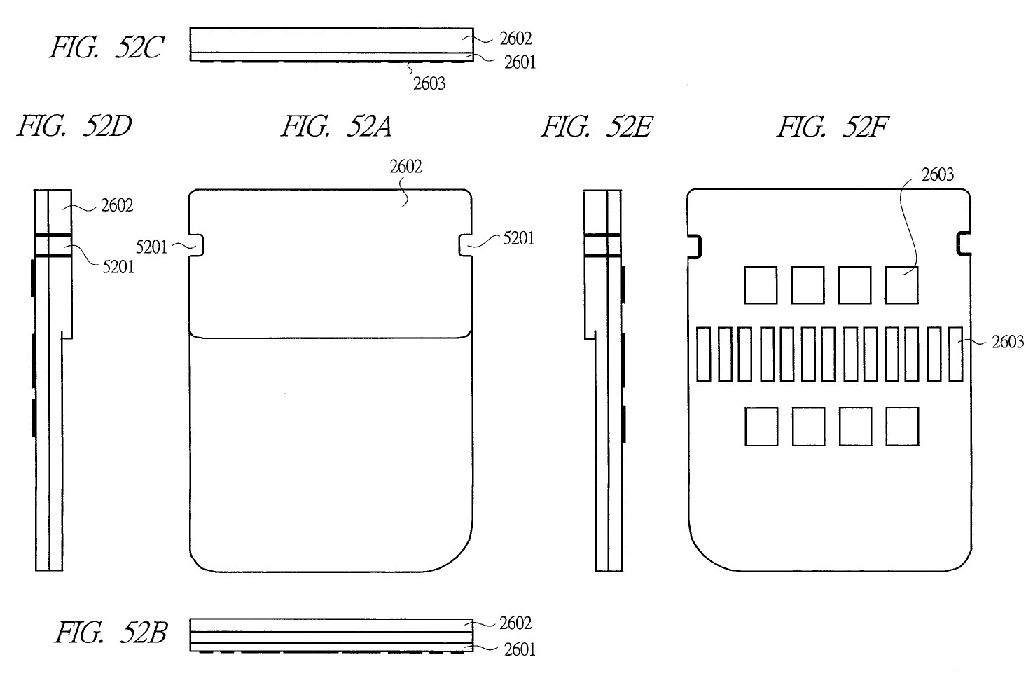

FIG. 52 is a drawing showing the outer shape of a thin memory card 4 with notch according to the fifteenth embodiment of the present invention, in which FIG. 52A is a plan view, FIG. 52B is a front view, FIG. 52C is a rear view, FIG. 52D is a left side view, FIG. 52E is a right side view, and FIG. 52F is a bottom view.

As shown in FIG. 52, each side surface of a mold 2602 has a notch 5201. This notch 5201 has a penetrating structure provided for the purpose of preventing the card dislocation and locking the card at a position. This penetration is advantageous in achieving a mechanically tough locking mechanism and latching strength.

While the first to fifteenth embodiments have been described in the foregoing, these embodiments and partial details described therein may be combined as appropriate.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention can be used in manufacturing industries of IC card, electronics and others.

1. A semiconductor device whose outer-shape dimensions are able to be equal to outer-shape dimensions of a full-size card under Plug-in SIM card standards or miniUICC standards when an external adaptor is attached thereto, the semiconductor device having outer-shape dimensions smaller than the outer-shape dimensions of the full-size card when the adaptor is not attached,
wherein the Plug-in SIM adaptor or the miniUICC adaptor and an IC card are integrated together when the semiconductor device is attached to the Plug-in SIM adaptor or the miniUICC adaptor,
the semiconductor device is physically separable from the Plug-in SIM adaptor or the miniUICC adaptor,
the semiconductor device has a flash memory chip mounted thereon,
the semiconductor device has card terminals for electrical connection to the Plug-in SIM adaptor or the miniUICC adaptor,
the semiconductor device and the card terminals are shaped to have a longitudinal portion and a short-side portion, and
at an arrangement position of the card terminals in the semiconductor device, a distance from the short-side portion of the semiconductor device on an insertion side into the adaptor to one end of the card terminals on a side near the short-side portion is longer than a distance from a half position of the semiconductor device in a longitudinal direction to the other end of the card terminals on a side away from the short-side portion.

2. A semiconductor device whose outer-shape dimensions are able to be equal to outer-shape dimensions of a full-size card under Plug-in SIM card standards or miniUICC standards when an external adaptor is attached thereto, the semiconductor device having outer-shape dimensions smaller than the outer-shape dimensions of the full-size card when the adaptor is not attached,
wherein the Plug-in SIM adaptor or the miniUICC adaptor and an IC card are integrated together when the semiconductor device is attached to the Plug-in SIM adaptor or the miniUICC adaptor,
the semiconductor device is physically separable from the Plug-in SIM adaptor or the miniUICC adaptor,
the semiconductor device has a flash memory chip mounted thereon,
the semiconductor device has card terminals for electrical connection to the Plug-in SIM adaptor or the miniUICC adaptor,
the semiconductor device is shaped to have a longitudinal portion and a short-side portion, and
when the semiconductor device is equally divided into four regions in a longitudinal direction, compared with a quarter region of the semiconductor device on an insertion side into the adaptor, a next adjacent quarter region and a further next quarter region have a higher area ratio of the card terminals occupying the quarter regions.

3. The semiconductor device according to claim 1,
wherein the card terminals include any one of a data terminal for data input/output of the semiconductor device, a control terminal to which a control signal for controlling an operation of the semiconductor device is input, and a clock terminal to which a clock signal is input.

4. A semiconductor device whose outer-shape dimensions are able to be equal to outer-shape dimensions of a full-size card under Plug-in SIM card standards or miniUICC standards when an external adaptor is attached thereto, the semiconductor device having outer-shape dimensions smaller than the outer-shape dimensions of the full-size card when the adaptor is not attached and having a flash memory chip mounted thereon,
wherein the Plug-in SIM adaptor or the miniUICC adaptor and an IC card are integrated together when the semiconductor device is attached to the Plug-in SIM adaptor or the miniUICC adaptor,
the semiconductor device is physically separable from the Plug-in SIM adaptor or the miniUICC adaptor,
the semiconductor device has a first portion with a first thickness and a second portion with a second thickness larger than the first thickness, and
the first portion corresponds to an insertion side into the Plug-in SIM adaptor or the miniUICC adaptor.

5. The semiconductor device according to claim 4,
wherein, compared with the number of semiconductor chips mounted or stacked on the first portion, the number of semiconductor chips mounted or stacked on the second portion is larger.

6. An adaptor having a secure IC chip with a security microcomputer function mounted thereon and operating as a SIM or miniUICC,
wherein a semiconductor device having a flash memory chip mounted thereon can be inserted into the adaptor, and
the adaptor has an upper surface and a lower surface, the lower surface is provided with connecter terminals which can make contact with card terminals of the semiconductor device, the upper surface is provided so as to face the connector terminals, and the semiconductor device can be inserted so as to be interposed between the upper surface and the lower surface.

7. The adaptor according to claim 6,
wherein the upper surface and the lower surface have a plate-like shape with two ends, one end forms an insertion port for the semiconductor device, and the other end is connected to a portion where the secure IC chip is mounted, and
the upper surface facing the lower surface is not provided and a portion of the upper surface is opened in the insertion port.
